(19) United States
(12) Patent Application Publication
(10) Pub. No.: US 2005/0093425 A1
(43) Pub. Date: May 5, 2005

(54) Optical sensor, method of manufacturing and driving an optical sensor, method of detecting light intensity

(75) Inventor: Yukihiro Sugiyama, Anpachi-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD, Osaka (JP)

(21) Appl. No.: 11/003,355

(22) Filed: Dec. 6, 2004

Related U.S. Application Data
(63) Continuation-in-part of application No. PCT/JP03/09577, filed on Jul. 29, 2003.

(30) Foreign Application Priority Data
Aug. 1, 2002 (JP) JP2002-225291
Sep. 6, 2002 (JP) JP2002-261244
Nov. 7, 2002 (JP) JP2002-324373

(51) Int. Cl. H01J 1/62; H01J 63/04

(52) U.S. Cl. 313/495

(57) ABSTRACT

In an optical sensor provided with an optically polarizable molecule, a pair of source electrode and drain electrode is electrically connected via a carbon nanotube. When a photosensitive molecule constituting the light sensitively polarizable layer polarizes upon receiving a light, conductance of the carbon nanotube varies. Since the variation of the conductance of the carbon nanotube incurs a variation of current value between the source electrode and the drain electrode, such variation is to be detected. Also, by forming a layer including the aligned, efficient connection with the source electrode and the drain electrode can be simply achieved. A small-sized optical sensor capable of performing with high precision and high sensitivity, manufacturing and driving method of such optical sensor, and method of light intensity detection are accomplished.

This is a Continuation-in-part of International Application No. PCT/JP2003/009577, filed on Jul. 29, 2003.

This application is based on the Japanese Patent Application No. 2002-225,291, the Japanese Patent Application No. 2002-261,244, and the Japanese Patent Application No. 2002-324,373, the content of which is incorporated hereinto by reference.

### BACKGROUND OF THE INVENTION

1. Field of the Invention

The present invention relates to an optical sensor, method of manufacturing and driving an optical sensor, and to method of detecting light intensity.

2. Description of the Related Art

Recently, demand for miniaturization and upgrading in sensitivity of an optical sensor has been remarkably increasing, and development of an optical sensor capable of detecting an optical signal through efficient conversion thereof to an electric signal has been eagerly longed for.

In view of such demand the present inventors have been developing a sensor in which a molecule that polarizes by light irradiation (hereinafter occasionally referred to as “photosensitive molecule”) is utilized as a light detecting substance. Successfully utilizing such photosensitive molecule as a light detecting unit can lead to detection of optical information at a higher sensitivity and precision level.

From such viewpoint, the inventors have already disclosed an image recognition device in which bacteriorhodopsin is utilized (see, Japanese Patent Application No. 2000-267223). The bacteriorhodopsin, which is a protein that constitutes a halophilic purple membrane with lipids, is a photoactive protein and differentially responds to light irradiation (FIG. 1).

The image recognition device described in the patent document 1 utilizes the response of the bacteriorhodopsin in an image sensor that extracts contours of a moving object and the like, by detecting an induced current induced to a pixel electrode when a layer of the oriented bacteriorhodopsins is electrically polarized by a light irradiation. This image recognition device detects an induced current, therefore incurs less noise than an image recognition device that detects an induced voltage. Accordingly, a signal can be detected even in case where an electrode is miniaturized. Also, a light detecting unit can be formed in an ultra-thin film because of utilizing a layer of the oriented bacteriorhodopsins.

### SUMMARY OF THE INVENTION

However, a signal originating from an electric polarization of a photosensitive molecule such as bacteriorhodopsin is so small that a sufficient current value is not always obtainable when detecting an induced current. Accordingly, it is sometimes necessary to amplify the signal to obtain a sufficient current value, in case of employing this signal as an optical sensor. Since such amplification system requires a large-scale apparatus, the optical sensor has so far had to be incorporated in a large-scale apparatus.

In view of the foregoing background, it is an object of the present invention to provide a small-sized and high-sensitivity optical sensor, method of manufacturing and driving thereof, and to method of detecting light intensity.

According to the present invention, there is provided an optical sensor, comprising a substrate; a source electrode and a drain electrode formed on the substrate; a carbon nanotube for electrically connecting the source electrode and the drain electrode; and a light sensitively polarizable layer disposed on the carbon nanotube.

In the optical sensor of the present invention, when a light is irradiated a polarization takes place in the light sensitive polarizable layer, and an induced charge is generated. At this stage, since the carbon nanotube has a feature to vary its conductance depending on intensity of an electric field, the induced charge serves as a trigger to vary a conductance of the carbon nanotube, and a current value between the source and drain electrodes varies. By detecting such variation of the current value, intensity and so on of the received light can be detected.

Though a signal generated by a polarization in the light sensitively polarizable layer is small, variation of the current value between the source and drain electrodes triggered by this signal becomes a large value. Therefore, a sufficiently large electric signal can be obtained for detecting whether a light has been received or not.

Also, since a carbon nanotube, which is highly conductive, is employed in the optical sensor of the present invention as an interconnect material connecting the source electrode and the drain electrode, a sufficient current value can be obtained despite miniaturizing the electrodes. Consequently, the optical sensor can be made smaller in dimensions. As a result, a number of the source electrodes and the drain electrodes, i.e. a number of pixels per unit area can be made greater.

According to the present invention, there is provided a method of manufacturing an optical sensor, comprising forming a source electrode and a drain electrode on a substrate; connecting the source electrode and the drain electrode with a carbon nanotube; and forming a light sensitively polarizable layer on the carbon nanotube.

According to the method of manufacturing an optical sensor of the present invention, a source electrode and a drain electrode are connected via a carbon nanotube, and a light sensitively polarizable layer is formed on the carbon nanotube. Therefore, a highly sensitive and miniaturized optical sensor containing a large number of pixels can be stably manufactured.

According to the present invention, there is provided a method of driving the mentioned optical sensor, comprising supplying a predetermined current between the source electrode and the drain electrode and detecting variation of the current value.

The method of driving an optical sensor of the present invention comprises supplying a predetermined current between the source electrode and the drain electrode; changing a conductance of the carbon nanotube according to a magnitude of polarization caused by receiving alight; and detecting a relevant variation of the current value. Based on a magnitude of the variation of the current value, intensity of the received light can be detected. Since the variation of the current value is greater than a case of directly detecting a polarization of a photosensitive molecule, measurement with high sensitivity and high precision can be performed.

According to the present invention, there is provided a method of detecting light intensity utilizing a sensor including a light sensitively polarizable layer and a carbon nanotube provided in the proximity thereof, comprising applying a voltage to the carbon nanotube; detecting variation of a current value in the carbon nanotube caused by irradiation of a light to the layer; and detecting light intensity based on the variation of the current value.

In the method of detecting light intensity of the present invention, the light sensitively polarizable layer polarizes by irradiation of a light, and an induced charge is generated. The induced charge serves as a trigger to vary a conductance of the carbon nanotube, and a current value between the source and drain electrodes varies. By detecting such variation of the current value, the light intensity can be detected. According to the method of the present invention, a relatively large variation of the current value can be obtained from a relatively small polarization signal, therefore light intensity can be measured with high precision and high sensitivity.

In the method of detecting light intensity of the present invention, the light sensitively polarizable layer may contain bacteriorhodopsin. Such arrangement assures stable polarization in the light sensitive polarizable layer. Consequently, detection of light intensity can be performed with high precision and high sensitivity.

In the optical sensor of the present invention, an insulating layer may be provided on a surface of the carbon nanotube. With such constitution, insulation between the carbon nanotube and the light sensitively polarizable layer can be ensured. Consequently, operational stability of the optical sensor can be improved.

In the optical sensor of the present invention, the insulating layer may be a polymer layer. With such constitution, the carbon nanotube surface can be sufficiently wrapped and therefore insulativeness can be stably secured. The polymer layer may be, for example, an organic polymer layer.

In the optical sensor of the present invention, the insulating layer may be constituted of a polymer layer wrapping around a rounded surface of the carbon nanotube.

In the optical sensor of the present invention, the insulating layer may be constituted of a polymer wound around a rounded surface of the carbon nanotube. With such constitution, the carbon nanotube surface can be uniformly wrapped. Also, a solid and stable wrapping layer can be obtained. Therefore operational stability of the optical sensor can be improved, which leads to upgrading of product reliability. Further, as a result of winding a polymer, a film thickness of the wrapping layer can be reduced. Consequently, conductance of the carbon nanotube can vary more securely.

In the present invention, the term of “polymer” refers to a molecule that has a sufficient molecular chain length for winding around a carbon nanotube. Also, the state that the polymer is “wound around” a rounded surface of the carbon nanotube refers to such a state that the molecular chain of the polymer is twined around a rounded surface thereof, thereby constituting a wrapping on the carbon nanotube surface.

In the method of manufacturing an optical sensor of the present invention, a step of forming a layer including the aligned carbon nanotubes may include forming an insulating layer including the wrapping molecule on the carbon nanotube surface. With such constitution, insulation between the carbon nanotube and the light sensitively polarizable layer can be ensured.

In the method of manufacturing an optical sensor of the present invention, a polymer may be employed as the wrapping molecule to form a polymer layer on the carbon nanotube surface. With such constitution, coverage of the insulating layer can be improved. Consequently, the carbon nanotube surface can be further stably insulated.

The method of manufacturing an optical sensor of the present invention may further comprise spreading over a liquid surface a dispersion in which a protein is dispersed for denaturing or unfolding the protein for use as the wrapping molecule, and winding the unfolded protein around a rounded surface of the carbon nanotube.

According to the manufacturing method of the present invention, a polymer can be wound around the carbon nanotube surface by a simple method. Therefore, the carbon nanotube-surface can be wrapped by a simple method. Consequently insulativeness of the carbon nanotube surface can be further ensured.

In the present invention, the polymer may be a polypeptide. By employing a polypeptide, a molecular chain thereof can be stably wound around the carbon nanotube. Also, in the present invention the polypeptide may be a denatured protein.

In the method of manufacturing an optical sensor of the present invention, a protein may be used as the polymer, such that the protein is denatured or is unfolded by spreading a dispersion thereof over a liquid surface, and the unfolded proteins are wound around a rounded surface of the carbon nanotube.

A denatured protein generally tends to expose its hydrophobic portion unlike a native protein. Therefore wrapping or winding around a rounded hydrophobic surface of the carbon nanotube can be more easily and securely executed. Also, by spreading a protein dispersion over a liquid surface, the protein can be more efficiently denatured by a surface tension at a gas-liquid interface, to thereby expose its hydrophobic portion. Meanwhile, in the present invention the “denaturation” of a protein refers to decay of a native structure of the protein molecule, deactivation of functions, or a conformation change except disconnection of a primary structure constituting the protein molecule, i.e. an amino-acid sequence, and an extent of the conformation change is not specifically defined.

In the present invention, the polymer may be a membrane protein. Since many of the membrane proteins have many hydrophobic amino acids in its interior region, employing a membrane protein permits stable denaturation or stable unfolding on a gas-liquid surface and efficient adsorption thereof to a rounded hydrophobic surface of the carbon nanotube, so as to stably wind around the carbon nanotube.

Accordingly, the optical sensor of the present invention comprises a substrate; a source electrode and a drain electrode formed on the substrate; a carbon nanotube for electrically connecting the source electrode and the drain electrode; a light sensitively polarizable layer disposed on the carbon nanotube. Therefore, a small signal generated by a polarization in the light sensitively polarizable layer serves as a trigger to obtain a large electric signal represented by variation of a current value between the source and drain electrodes, and by detecting such variation of the current value, an optical sensor capable of detecting a light with high precision and high sensitivity as well as a driving method thereof can be obtained.

Also, according to the present invention, there is provided a method of manufacturing by which a highly sensitive, precise and miniaturized optical sensor containing a large number of pixels can be stably manufactured.

Further, according to the present invention, since light intensity is detected through applying a voltage to the carbon nanotube, detecting variation of a current value in the carbon nanotube caused by irradiation of a light to the light sensitive polarizable layer, and based on the variation of the current value, a relatively large variation of the current value can be obtained from a relatively small polarization signal, therefore a method of detecting by which light intensity can be measured with high precision and high sensitivity can be accomplished.

This summary of the invention does not necessarily describe all necessary features so that the invention may also be a sub-combination of these described features.

### BRIEF DESCRIPTION OF THE DRAWINGS

The foregoing and other objects, features and advantages will become more apparent through the following description of the preferred embodiments and the accompanying drawings listed hereunder.

FIG. 1 is a graph showing light irradiation to bacteriorhodopsin and electric response thereto;

FIG. 2 is a schematic cross-sectional view showing an optical sensor according to an embodiment;

FIG. 3 is a schematic diagram showing an optical sensor according to an embodiment;

FIGS. 4A to 4G are schematic cross-sectional views showing manufacturing steps of an optical sensor according to an embodiment;

FIG. 5 is a schematic perspective view showing a structure of an optical sensor according to an embodiment;

FIG. 6 is a schematic perspective view showing a formation method of a monolayer of aligned carbon nanotubes;

FIGS. 7A to 7F are schematic top views showing method of connecting a source electrode and a drain electrode utilizing a carbon nanotube;

FIGS. 8A to 8F are schematic cross-sectional views showing method of connecting a source electrode and a drain electrode utilizing a carbon nanotube;

FIGS. 9A to 9D are schematic cross-sectional views showing a formation and multilayering method of a protein monolayer film;

FIGS. 10A to 10E are schematic cross-sectional views showing a formation and multilayering method of a denatured protein monolayer film;

FIG. 11 is a schematic cross-sectional view showing an image recognition device according to an embodiment;

FIG. 12 is a graph showing electric polarization characteristics of bacteriorhodopsin by light irradiation;

FIGS. 13A and 13B are schematic drawings showing an output image of an image recognition device according to an embodiment;

FIG. 14 is a graph showing Π-A curve of a bacteriorhodopsin molecule;

FIGS. 15A to 15E are schematic cross-sectional views showing method of connecting a source electrode and a drain electrode utilizing a carbon nanotube;

FIG. 16 includes a plan view and a side view showing an electrode according to an embodiment;

FIG. 17 shows an AFM image of a monolayer of aligned carbon nanotubes supported laterally by denatured bacteriorhodopsins;

FIG. 18 shows an AFM image of a monolayer of aligned carbon nanotubes prepared without any lateral support;

FIGS. 19A to 19F are schematic drawings showing a manufacturing method of a carbon nanotube-based structure according to a working example;

FIG. 20 shows a TEM image of a carbon nanotube-based structure according to a working example;

FIG. 21 is a schematic cross-sectional view showing an optical sensor according to an embodiment;

FIGS. 22A to 22E are schematic cross-sectional views showing manufacturing steps of an optical sensor according to an embodiment;

FIGS. 23A to 23E are schematic top views showing method of connecting a source electrode and a drain electrode utilizing a carbon nanotube;

FIGS. 24A to 24E are schematic cross-sectional views showing method of connecting a source electrode and a drain electrode utilizing a carbon nanotube;

FIGS. 25A to 25D are schematic cross-sectional views showing method of connecting a source electrode and a drain electrode utilizing a carbon nanotube; and

FIG. 26 is a schematic cross-sectional view showing an image recognition device according to an embodiment.

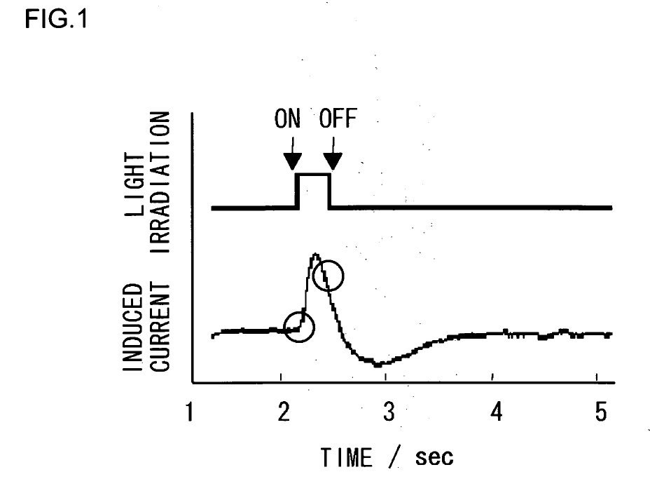

### DETAILED DESCRIPTION OF THE INVENTION

The invention will now be described based on the preferred embodiments. This does not intend to limit the scope of the present invention, but exemplify the invention.

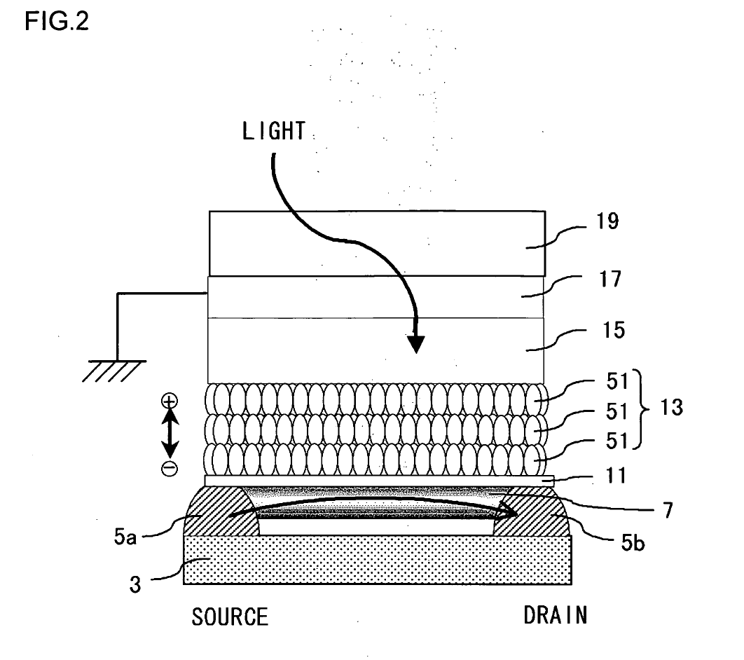

Hereunder, preferred embodiments of an optical sensor according to the present invention will be described. FIG. 2 is a schematic cross-sectional view showing a constitution of an optical sensor according to the present invention. In FIG. 2, a substrate 3, a source electrode 5a and a drain electrode 5b provided on the substrate 3, a carbon nanotube 7 connecting these electrodes, an insulating layer 11 formed on the carbon nanotube 7, and a light sensitively polarizable layer 13 formed on the insulating layer 11 are included.

The light sensitively polarizable layer 13 contains a molecule that polarizes when irradiated (hereinafter referred to as “photosensitive molecule), so that the photosensitive molecule polarizes by irradiation of a light and an induced charge is generated. Since the induced charge varies a conductance of the carbon nanotube 7, a current value between the source electrode 5a and the drain electrode 5b varies.

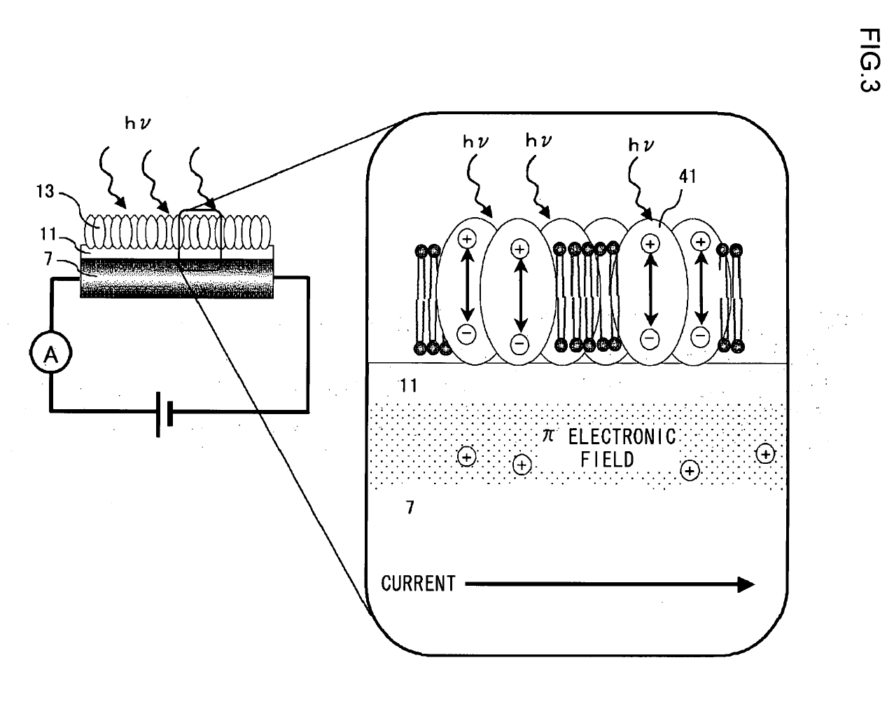

FIG. 3 schematically shows how a conductance of the carbon nanotube 7 varies. Referring to FIG. 3, it is presumed that a conductance of the carbon nanotube 7 varies because a charge generated by a photoelectric polarization of the photosensitive molecule causes a variation of an electronic field of the carbon nanotube 7. Because of the variation of conductance of the carbon nanotube 7, a value of a current flow through the carbon nanotube 7 varies. In the optical sensor shown in FIG. 2, since the carbon nanotube 7 is used for connecting the source electrode 5a and the drain electrode 5b and the light sensitively polarizable layer 13 is provided on the carbon nanotube 7, a current value between the source electrode 5a and the drain electrode 5b varies through the carbon nanotube 7.

By detecting this variation of the current value, a small signal generated by a photoelectric polarization of the photosensitive molecule can be detected as a current value variation at a level of nano-ampere (10⁻⁹ A). Therefore, a highly sensitive optical sensor that converts an optical signal into an electric signal can be obtained.

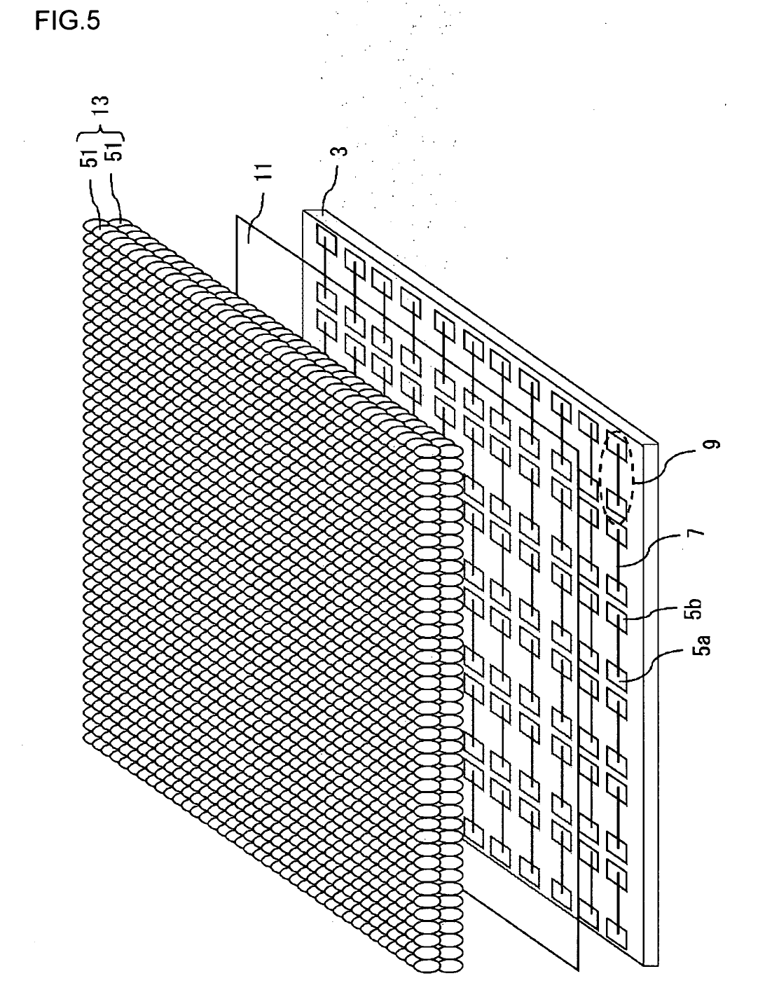

In the optical sensor of the present invention, the source electrode and the drain electrode may be two-dimensionally aligned on a surface of the substrate. For example, the source electrode and the drain electrode can be aligned as shown in FIG. 5.

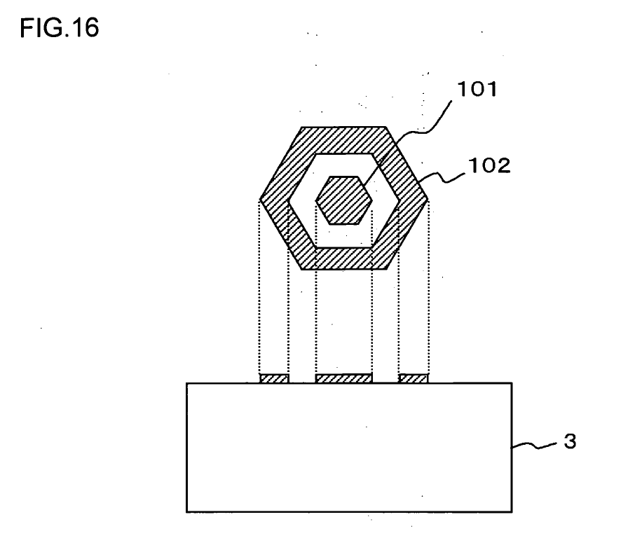

Also, FIG. 16 shows another example of the disposition of the source electrode and the drain electrode. The disposition of FIG. 16 includes a first electrode 101 and a second electrode 102 disposed so as to surround the first electrode 101 with a gap therebetween. Either of the first electrode 101 or the second electrode 102 may be designated as the source electrode, and the other as the drain electrode. Employing such configuration of the electrodes makes it relatively easy to connect the source electrode and the drain electrode with the carbon nanotube, thereby improving production efficiency.

In the optical sensor of the present invention, an insulating layer may be provided between the carbon nanotube and the light sensitively polarizable layer as shown in FIG. 2. With such constitution, a current leak between the carbon nanotube and the light sensitively polarizable layer can be prevented.

The insulating layer may mainly contain a protein, for example. By such constitution the insulating layer can be formed in a thin film, therefore a polarization caused in the light sensitively polarizable layer can effectively conduct a variation of conductance of the carbon nanotube.

Also, the insulating layer may mainly contain a denatured protein. For example, the insulating layer may contain denatured bacteriorhodopsin.

In the optical sensor of the present invention, the light sensitively polarizable layer can mainly contain a light sensitively polarizable molecule. For example, in the optical sensor of the present invention, the light sensitively polarizable layer may contain a layer of the oriented light sensitively polarizable molecules. Since such constitution permits efficient concentration of optical signals, precision and sensitivity of the optical sensor can be upgraded. Also, it becomes possible to detect an optical signal per a minute area, therefore the optical sensor can be miniaturized.

In the optical sensor of the present invention, the light sensitively polarizable layer may also contain oriented bacteriorhodopsin. The bacteriorhodopsin is a photosensitive molecule, and precisely causes a polarization with an optical signal because of its high structural stability among proteins. Accordingly, precision and sensitivity of the optical sensor can be further upgraded. Also, durability of the optical sensor can be improved. As a specific example of a layer containing oriented bacteriorhodopsins, oriented purple membranes can be cited.

FIG. 3 is a schematic diagram showing an optical sensor in which a purple membrane is employed. The light sensitively polarizable layer 13 is formed of a purple membrane, and constituted of bacteriorhodopsin 41 that is a photosensitive molecule and lipids. Meanwhile, in the present specifications, a protein monolayer film 51 and the light sensitively polarizable layer 13 will be schematically shown as FIG. 2 as the case may be, including a case where a photosensitive molecule and another ingredient is contained.

Also, the light sensitively polarizable layer may be constituted of a plurality of layers each containing oriented bacteriorhodopsins. With such constitution, sensitivity of the optical sensor can be upgraded.

As the photosensitive molecule, for example a synthetic polymer or a biomolecule capable of performing photoelectric conversion can be employed. Among biomolecules, for example a molecule having a porphyrin ring such as chlorophyll a may be employed.

In the optical sensor of the present invention, either a single wall carbon nanotube (SWCNT) or a multi-wall carbon nanotube (MWCNT) may be employed, as the carbon nanotube. Between them an SWCNT of a metallic nature can be suitably used as an interconnect material for electrically connecting the source electrode and the drain electrode, because its conductance is sensitively changeable depending on an electronic environment.

Hereunder, the optical sensor and a manufacturing method thereof according to the present invention will be described in details referring to some embodiments.

### First Embodiment

The optical sensor according to this embodiment is shown in FIGS. 2 and 3. The source electrode 5a and the drain electrode 5b connected via the carbon nanotube 7 are provided on the substrate 3, and the insulating layer 11 is formed on the respective surfaces of the source electrode 5a and the drain electrode 5b connected via the carbon nanotube 7. The carbon nanotube 7 is an SWCNT. The protein monolayer film 51 is provided on the insulating layer 11 to serve as the light sensitively polarizable layer 13. On the light sensitively polarizable layer 13, a transparent protective layer 15 is provided for protecting the light sensitively polarizable layer 13, and a transparent conductive layer 17 and a transparent substrate 19 are provided in this sequence on the protective layer 15. In FIG. 2 the transparent conductive layer 17 is grounded, while it is also possible to apply an offset voltage to the transparent conductive layer 17. In this case, for example the substrate 3 can be grounded.

The optical sensor according to this embodiment operates as follows.

(I) Current is supplied between the source electrode 5a and the drain electrode 5b.

(II) The photosensitive molecule contained in the light sensitively polarizable layer 13 polarizes by light irradiation.

(III) This polarization serves as a trigger signal to vary a conductance of the carbon nanotube 7 connecting the source electrode 5a and the drain electrode 5b. Because of this conductance variation, value of the current flow between the source electrode 5a and the drain electrode 5b varies.

(IV) By measurement of the variation of the current value between the source electrode 5a and the drain electrode 5b, light intensity is detected.

Otherwise, as subsequently described in the second embodiment, it is also possible to apply a voltage between the source electrode 5a and the drain electrode 5b without supplying a current instead of the step (I), so that the trigger signal of the step (II) is utilized as a switch to supply a current between the source electrode 5a and the drain electrode 5b. In other words, it is also possible to set so that a current is turned on upon receipt of a light, keeping the current from running while a light is not received. By measuring this current value, light intensity can be detected.

Accordingly, in the optical sensor of this embodiment, a photoinduced charge of the photosensitive molecule is not extracted as it is as a detection signal, but is utilized as a trigger signal for causing a variation of the current between the source electrode 5a and the drain electrode 5b. In other words the photoinduced charge of the photosensitive molecule is utilized as a trigger signal for a variation of a conductance of the carbon nanotube disposed between the source/drain electrodes, so that the current value between the source electrode 5a and the drain electrode 5b, which varies according to the trigger signal, is to be detected.

In case of employing a single wall carbon nanotube (SWCNT) as the carbon nanotube 7 used in the optical sensor of this embodiment, the conductance prominently varies according to a surrounding electronic environment. Therefore in the optical sensor of this embodiment, by connecting the source electrode 5a and the drain electrode 5b via an SWCNT, it becomes possible to detect a signal generated by a photoelectric polarization of the photosensitive molecule as a current variation at a level of nano-ampere (10⁻⁹ A). Consequently, sensitivity of the optical sensor can be improved with respect to a case of directly detecting a photoelectric polarization of the photosensitive molecule.

Meanwhile, referring to the optical sensor of this embodiment, it has been experimentally proven that a polarization speed (inverse of a delay time) of bacteriorhodopsin shows a monotonous increase in proportion to an increase of intensity of a light irradiated to the optical sensor. Also, the greater the irradiated light intensity becomes, the more the drain current flow through the carbon nanotube because of polarization of the bacteriorhodopsin increases.

Also, a multi-wall carbon nanotube (MWCNT) may be used as the carbon nanotube 7. For example in case of employing a semiconducting MWCNT, it is presumed that when the photosensitive molecule polarizes upon receipt of a light the source electrode 5a and the drain electrode 5b become conductive. Further, the substrate, the source electrode 5a and the drain electrode 5b may be constituted of a semiconductor.

Now, a method of manufacturing the optical sensor shown in FIG. 2 will be described. The optical sensor of this embodiment is manufactured through the following steps.

(i) Forming the source electrode 5a and the drain electrode 5b on the substrate 3.
(ii) Connecting the source electrode 5a and the drain electrode 5b with the carbon nanotube 7.
(iii) Forming the insulating layer 11 on the carbon nanotube 7.
(iv) Forming the light sensitively polarizable layer 13 on the insulating layer 11.
(v) Forming a multilayered structure by bonding the substrate 3 and the transparent substrate 19.

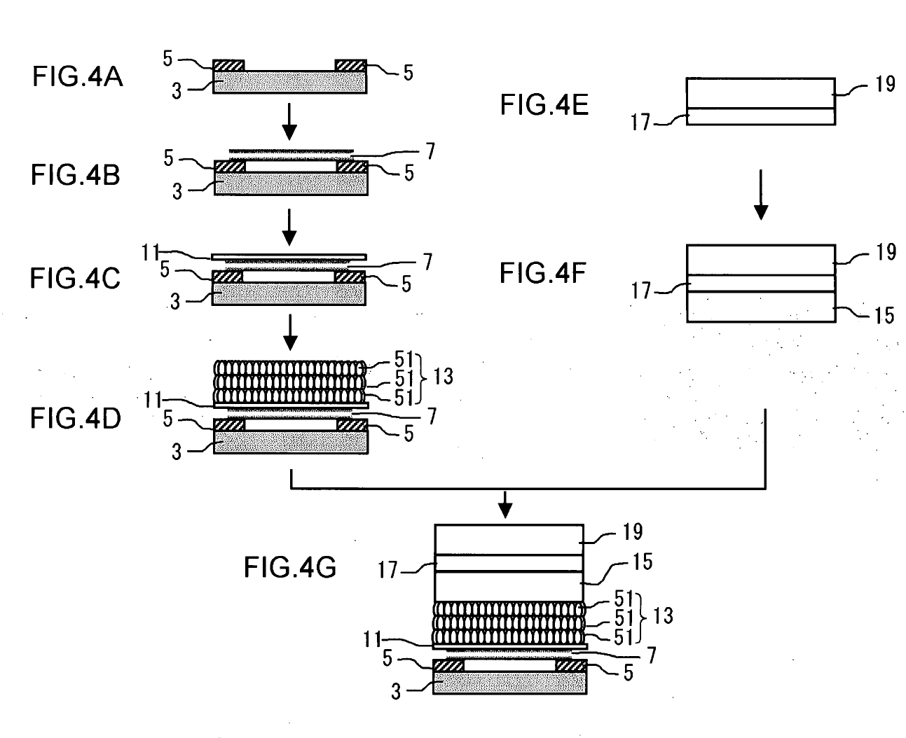

Hereunder, the respective steps will be described referring to the cross-sectional drawings of FIGS. 4A to 4G.

(i) Forming the Source Electrode 5a and the Drain Electrode 5b on the Substrate 3.

As shown in FIG. 4A, a pair of electrodes, which will respectively serve as the source electrode 5a and the drain electrode 5b, is formed on one of the surfaces of the substrate 3. In case of two-dimensionally disposing the source electrode 5a and the drain electrode 5b on the surface of the substrate 3, for example a configuration shown in FIG. 5 can be adopted. As the substrate 3, an insulative material or a semiconducting material such as silicon, SiC, MgO, silica, and the like may be utilized.

A mask is formed on the surface of the substrate 3 by photolithography, dry etching or wet etching, etc. The source electrode 5a and the drain electrode 5b can be formed on the substrate 3 where the mask is formed, by bonding a metal thin plate, vapor-depositing a metal on the substrate 3, or sputtering etc. For constituting the source electrode 5a and the drain electrode 5b, for example a metal that can form carbide such as Ti or Cr, a low-resistance metal such as Au, Pt, Cu, or an alloy of these metals such as an Au-Cr alloy may be employed. Especially, it is preferable to use a metal that can form carbide, since contact resistance between the carbon nanotube 7 and the source electrode 5a and the drain electrode 5b can be reduced. Au is also preferable because this is a precious metal and has a low specific electric resistance.

Also, in case of employing a precious metal such as Au or Pt, or a metal that has a low affinity with carbon as the source electrode 5a and the drain electrode 5b, it is preferable to provide a bonding layer containing a metal capable of forming a carbide such as Ti or Cr on a surface of the source electrode 5a and the drain electrode 5b, in order to reduce contact resistance with the carbon nanotube 7. As an example of such electrode, an electrode constituted of Au with a Ti layer provided thereon can be cited. By such constitution, contact resistance between the source electrode 5a, the drain electrode 5b and the carbon nanotube 7 can be reduced. Referring to a method of forming the bonding layer, vapor-deposition of a metal capable of forming carbide can be cited as an example.

A thickness of the source electrode 5a and the drain electrode 5b may be set, for example, in a range of 0.5 nm to 100 nm both inclusive. A gap between the source electrode 5a and the drain electrode 5b is to be appropriately designed according to a length of the carbon nanotube 7. For example, the gap is in a range of 50 nm to 10 μm both inclusive.

Further, each of the source electrodes 5a and the drain electrodes 5b provided on the substrate 3 can be connected to a current detecting device from the rear face of the substrate 3 via a wiring. With such arrangement, it becomes possible to detect the respective current values between each of the source electrodes 5a and the drain electrodes 5b.

ii) Connecting the Source Electrode 5a and the Drain Electrode 5b with the Carbon Nanotube 7.

The source electrode 5a and the drain electrode 5b formed on the surface of the substrate 3 as shown in FIG. 4A are electrically connected via the carbon nanotube 7 as shown in FIG. 4B. The carbon nanotube 7 may have a length of, for example, 50 nm to 10 μm both inclusive. Also, either an SWCNT or an MWCNT may be employed.

As a method of connecting the source electrode 5a and the drain electrode 5b with the carbon nanotube 7, for example adhering the carbon nanotube alignment layer to the surface of the substrate 3, moving the carbon nanotube 7 with a probe of an AFM (atomic force microscope), or horizontally growing along the substrate 3 from a lateral face of the source electrode 5a and the drain electrode 5b may be cited as examples. In this and the second embodiments, the method of adhering the carbon nanotube alignment layer to the surface of the substrate 3 will be described. Other methods will be subsequently described referring to the third and the fourth embodiments.

The step of connecting the source electrode 5a and the drain electrode 5b with the carbon nanotube 7 includes forming a monolayer of the aligned carbon nanotubes 7 and adhering the alignment layer of the carbon nanotube 7 to the surface of the substrate 3 where the source electrode 5a and the drain electrode 5b are provided. Also, thereafter, a step of selectively removing the carbon nanotube 7 adhered in a region other than between the source electrode 5a and the drain electrode 5b is to be performed.

The alignment of the carbon nanotube 7 can be formed as follows. Firstly, the carbon nanotube 7 and a protein are dispersed in a dispersion medium. As a dispersion medium, for example 33 v/v % DMF (dimethylformamide) aqueous solution may be used. The protein serves as a supporting member for retaining the carbon nanotubes in an oriented state. For example either a purple membrane or bacteriorhodopsins contained in the purple membrane may be employed to serve as a supporting member in this way. The purple membrane can be extracted from halophilic bacteria such as Halobacterium salinarum. For extraction of the purple membrane, the method described in “Methods in Enzymology” 31, A, pp. 667-678 (1974) may be utilized. An excessive amount of the carbon nanotube 7 is added to the dispersion of the supporting member, to be dispersed by an ultrasonic disperser or the like. Aggregation of the carbon nanotube 7 remaining in the dispersion is removed.

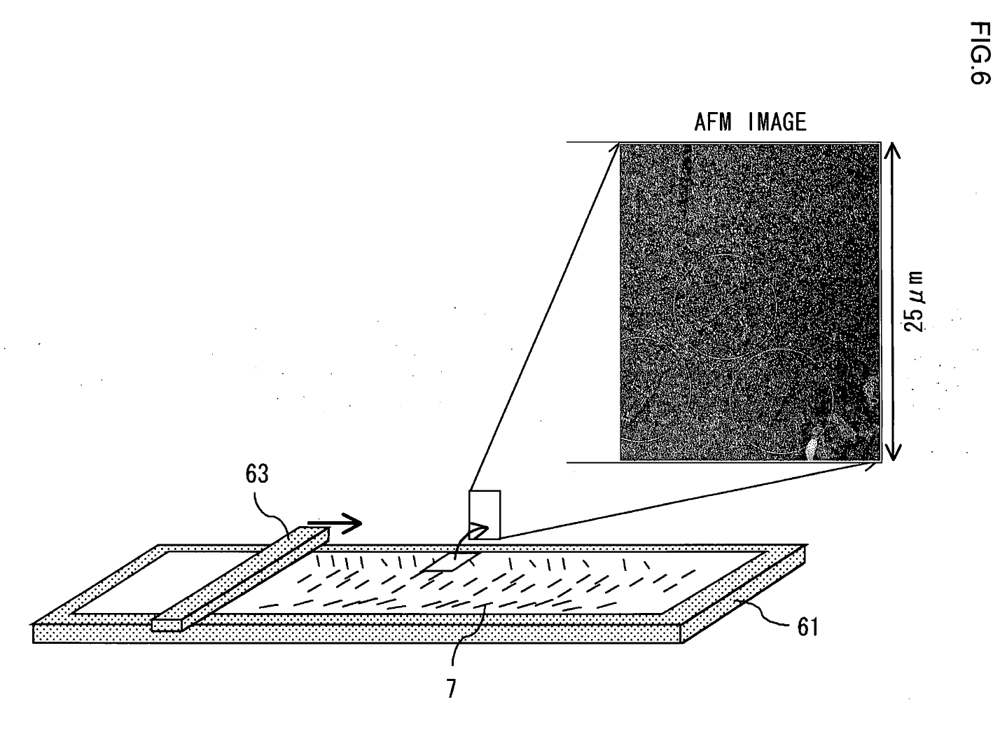

The dispersion of the carbon nanotube 7 and the supporting member is slowly spread over a surface of the filled liquid contained in a tank with a syringe or the like, as shown in FIG. 6. At this stage, an interface film including the carbon nanotube 7 is obtained. In this embodiment a Langmuir trough 61 is used as the tank, and pure water adjusted at pH 3.5 with HCl was used as the filled liquid.

Then the interface film including the carbon nanotube 7 is put to static reaction so that interface denaturation of the protein is incurred because of a surface tension of the filled liquid. In case of using the purple membrane as the supporting member, it is preferable to continue the static reaction for at least five hours at a room temperature in order that the entirely interfacial denaturation of the bacteriorhodopsins in the purple membrane is completed. Through such step, an aggregation of the denatured protein can become the supporting member of the carbon nanotube 7, so that the carbon nanotubes 7 can maintain a given orientation. An interface monolayer film in which the carbon nanotubes 7 are aligned generally in parallel can be obtained by compressing utilizing a movable barrier 63 of the Langmuir trough as a partition plate. In case of using the purple membrane as the supporting member for example, it is preferable to compress at a compressing speed of 20 cm²/min. until surface pressure becomes 15 mN/m. Orientation of the carbon nanotubes 7 can be confirmed with an AFM (atomic force microscope) or the like. FIG. 6 shows an AFM image of the carbon nanotube 7, and each of the carbon nanotubes 7 is seen in the white circles.

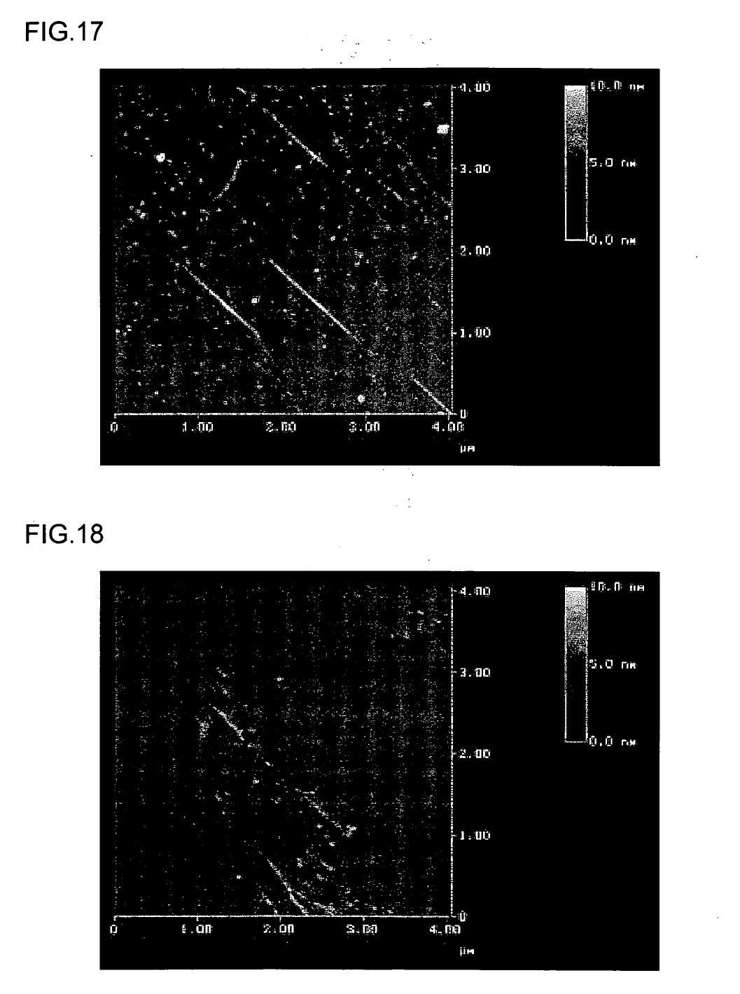

Also, FIG. 17 shows an AFM image of the alignment layer of the carbon nanotube 7 formed using the purple membrane as the supporting member. By contrast, FIG. 18 shows an AFM image of the alignment layer of the carbon nanotube 7 that went through the same process but without the supporting member. Referring to FIGS. 17 and 18, a biomolecule visualizing and measuring instrument BMVM-X1 (modified from Nano Scope IIIa manufactured by Digital Instruments, Inc.) was employed for the AFM observation. As a probe, AFM tip of monocrystalline silicon (NCH) was used, and the AFM measurements were set in the tapping mode. In addition, the measuring range was set for 4 μm×4 μm (Z10 nm).

In view of FIGS. 17 and 18, it is proven that in case of using the purple membrane as the supporting member the supporting component is adhered on the surface of the carbon nanotube 7. Also, it has been confirmed that orientability of the carbon nanotubes is improved by using the supporting member as shown in FIG. 17, and that the carbon nanotubes is aligned generally in parallel. In case where the carbon nanotubes alone were used as FIG. 18, though an alignment can be achieved to a certain extent, orientability is lowered at the step of film deposition. On the other hand in case of FIG. 17, since the orientation of the carbon nanotubes is retained by the supporting member mainly containing denatured bacteriorhodopsin, the high orientability is maintained even after the film deposition. Meanwhile in FIGS. 6, 17 and 18, as the carbon nanotube 7, a single wall carbon nanotube manufactured by CNI (Carbon Nanotechnologies Inc.) (Open-end type, approx. 1 nm in diameter and approx. 93% in purity) was employed.

The alignment layer of the carbon nanotubes 7 obtained in this way is adhered to a surface of the electrodes formed in the step (i) by a horizontal transfer method. The horizontal transfer method refers to a method of bringing the substrate into contact with a liquid with the substrate surface oriented parallel to the alignment layer over the liquid surface; and lifting horizontally the substrate so that the interfacial film including the alignment layer on the liquid surface transfers to the substrate surface. In this way the alignment layer of the carbon nanotubes 7 is formed on the substrate surface where the source electrode 5a and the drain electrode 5b are provided.

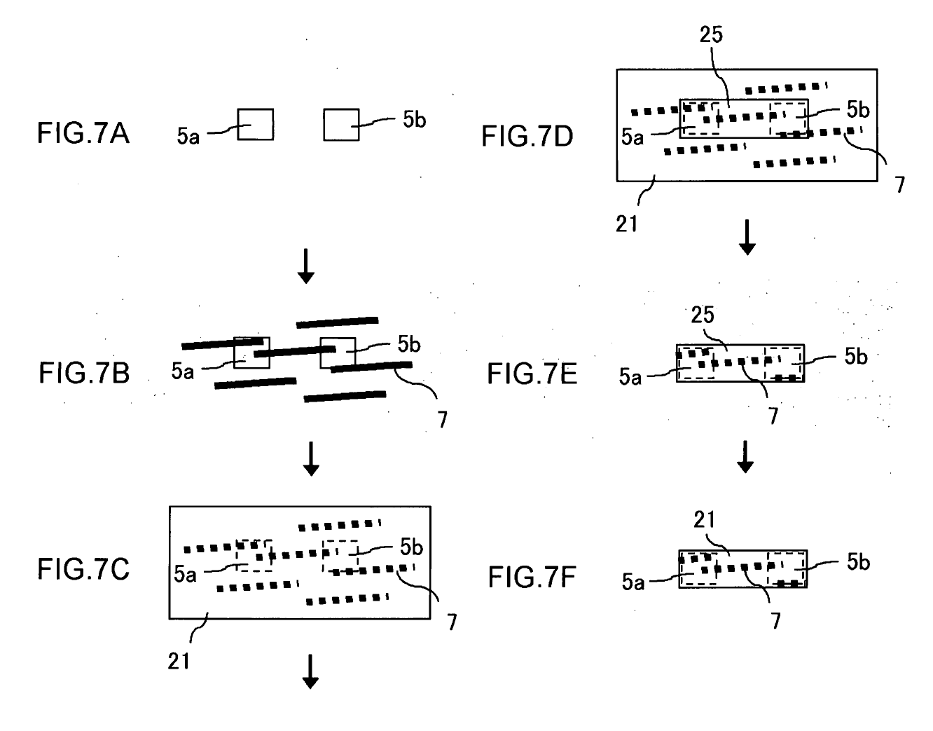

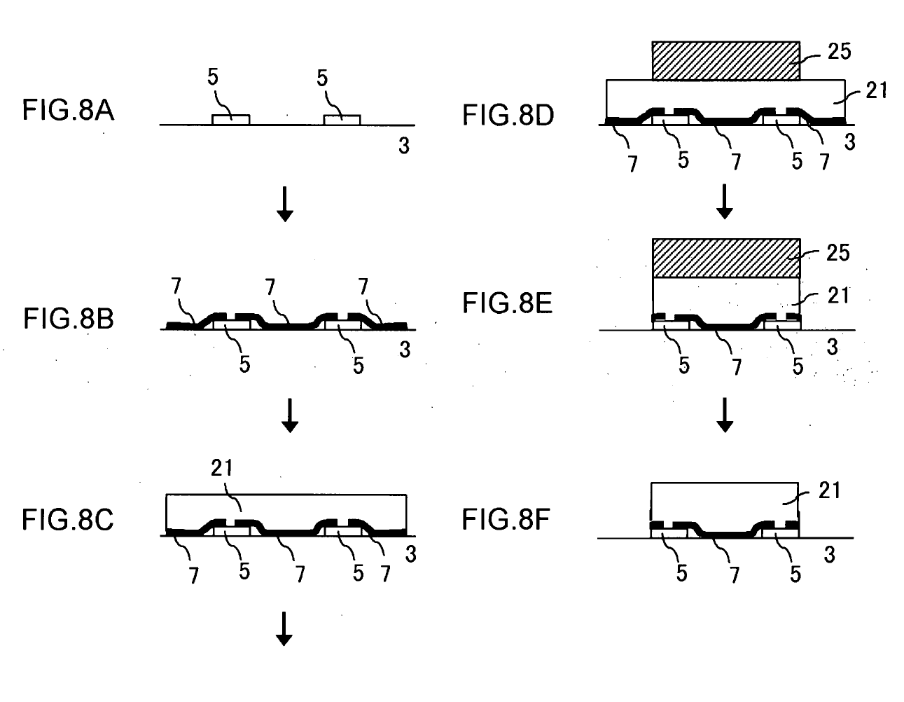

The subsequent steps will be described referring to top views of FIGS. 7A to 7F and cross-sectional views of FIGS. 8A to 8F. Here, the steps of FIGS. 7A to 7F respectively correspond to the steps of FIGS. 8A to 8F.

To start with, as shown in FIGS. 7A and 8A, the source electrode 5a and the drain electrodes 5b are formed on the substrate 3. Then as shown in FIGS. 7B and 8B, the alignment layer of the carbon nanotube 7 is adsorbed to the source electrode 5a and the drain electrode 5b. Thereafter as FIGS. 7C and 8C, an insulating layer 21 is formed on the surface of the alignment layer of the carbon nanotube 7 by plasma CVD method and the like. For example SiO₂ can be employed as the insulating layer 21. Also, the insulating layer 21 may be formed in a thickness of for example 1 nm to 1 μm both inclusive.

After the above, as shown in FIGS. 7D and 8D, a resist layer 25 is formed for removing the carbon nanotube 7 adsorbed to an unnecessary region leaving only the carbon nanotube 7 adsorbed to an upper portion of the source electrode 5a and the drain electrode 5b and between these electrodes. Then as shown in FIGS. 7E and 8E, the insulating layer 21 and the carbon nanotube 7 located in a region where the resist layer 25 is not provided is removed by dry etching or wet etching, etc. Finally the resist layer 25 is removed by a solution that only dissolves the resist layer 25 without dissolving the insulating layer 21.

Through the foregoing steps, the substrate 3 on which the carbon nanotube 7 is disposed between the source electrode 5a and the drain electrode 5b and the carbon nanotube 7 in an unnecessary region has been removed is obtained as shown in FIGS. 7F and 8F.

In this embodiment, since the insulating layer 21 is provided on the carbon nanotube 7 as described above, there is no need to remove the insulating layer before proceeding to the step of (iii), therefore the manufacturing process can be simplified in comparison with a case where another mask than an insulating material is provided.

Also, in case where a metal capable of forming a carbide is included in the surface of the source electrode 5a and the drain electrode 5b, a carbide is formed on the surface of the source electrode 5a and the drain electrode 5b by appropriately performing an annealing process, for example heating up to higher than 1000 degree centigrade in vacuum, after the step of FIGS. 7B and 8B, and resultantly electric contact can be improved.

Further, it is also possible to provide on the surface of the substrate 3 a mask having an opening only at a position corresponding to an upper portion of the electrodes after removing the insulating layer 21, to thereby form a metal layer that further constitutes an electrode on the source electrode 5a and the drain electrode 5b respectively. For forming such metal layer, similar methods to the step (i) such as metal vapor deposition or sputtering and the like can be employed. As a result of such constitution, the carbon nanotube 7 connecting the source electrode 5a and the drain electrode 5b is disposed between the upper and lower metal layers, thereby achieving better electric contact.

As described above, according to this embodiment the source electrode 5a and the drain electrode 5b can be simply and efficiently connected by utilizing the monolayer film in which the carbon nanotube 7 is aligned. And as shown in FIG. 5, in case of defining a region between a pair of source electrode 5a and drain electrode 5b as a pixel 9, a current flow through each pixel 9 can be detected. Accordingly, the pixel 9 can be miniaturized. For example, it becomes possible to dispose 100 million pixels/cm².

(iii) Forming the Insulating Layer 11 on the Carbon Nanotube 7.

As shown in FIG. 4C, an insulating layer 11 is formed on the carbon nanotube 7, which has been formed on the source electrode 5a and the drain electrode 5b in the step (ii).

For forming the insulating layer 11, for example a polymer such as polyimide may be spin-coated over the surface of the substrate 3 where the carbon nanotube 7 is provided.

Also, for example, a polymer such as polyimide may be built up in a form of accumulated layers of monolayer films.

Further, it is also possible to form a membrane constituted of a denatured protein, and to adhere the membrane by horizontal transfer method to the surface of the substrate 3 where the source electrode 5a, the drain electrode 5b and the carbon nanotube 7 are provided, for use as the insulating layer 11. As the membrane constituted of a denatured protein, for example denatured bacteriorhodopsin can be cited. Otherwise, a purple membrane containing bacteriorhodopsins may be employed. The purple membrane can be separated from halophilic bacteria such as Halobacterium salinarum, as in the step (ii).

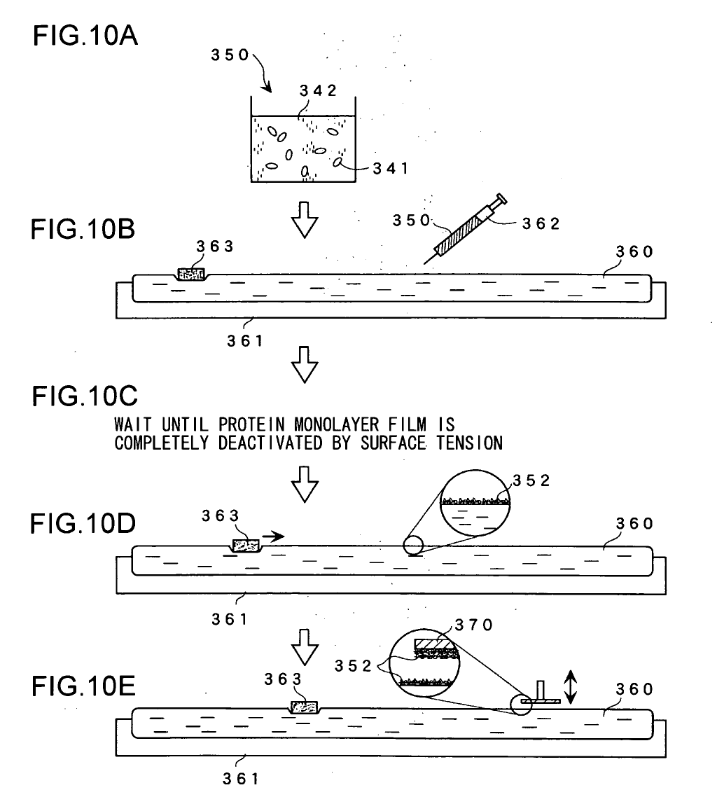

Referring to FIGS. 10A to 10E, description on a case where the purple membrane is used will be given hereunder.

Firstly, a purple membrane including bacteriorhodopsins 341 was dispersed in a dispersion medium 342, to prepare a protein spreading liquid 350. This is slowly spread over a surface of the filled liquid 360 contained in a tank with a syringe 362 or the like. In this embodiment a Langmuir trough 361 is used as the tank. Also, in case of using the bacteriorhodopsin 341 as the protein, for example 33 v/v % DMF (dimethylformamide) aqueous solution may be used as a dispersion medium 342. In this case, for example pure water adjusted at pH 3.5 with HCl can be used as the filled liquid 360.

Through static reaction of the protein monolayer film obtained on the filled liquid 360 for a predetermined period of time, interface denaturation of the protein is incurred because of a surface tension and a denatured protein monolayer film 352 is obtained. In case of using the bacteriorhodopsin 341, it is preferable to continue the static reaction for at least five hours at a room temperature.

Then the monolayer film formed over the liquid surface of the filled liquid 360 is compressed utilizing a movable barrier 363 of the Langmuir trough 361 as a partition plate, until a predetermined surface pressure is obtained. In case of the bacteriorhodopsin 341, it is preferable to compress until surface pressure becomes 15 mN/m.

Meanwhile, a surface pressure is a one-dimensional pressure indicated by a force per unit length. The monolayer film is formed in a sheet shape over the surface of the filled liquid, therefore when compressed from a lateral side a one-dimensional force is applied from a lateral direction. The surface pressure at this stage is obtained by dividing such force by a one-dimensional length of the lateral side of the monolayer film to which the force is applied.

After the compression, the denatured protein monolayer film 352 is adhered to the surface of the substrate 3 obtained through the step (ii) by horizontal transfer method. Also, by repeating the horizontal transfer method, the denatured protein monolayer film 352 can form accumulated layers. By adjusting a number of accumulated films, a thickness of the insulating layer 11 can be controlled. For example, since a thickness of a layer of the denatured protein monolayer film 352 is approx. 1.5 nm, the insulating layer 11 can be formed in a predetermined thickness by an increment of 1.5 nm.

(iv) Forming the Light Sensitively Polarizable Layer 13 on the Insulating Layer 11.

As shown in FIG. 4D, the light sensitively polarizable layer 13 is formed on the surface of the insulating layer 11 formed through the step of (iii). The light sensitively polarizable layer 13 can be constituted of a monolayer film of an optically polarizable molecule or a multilayer thereof.

The light sensitively polarizable layer 13 may be constituted of for example a layer of the oriented bacteriorhodopsins. The alignment layer of bacteriorhodopsins is preferably employed because it stably polarizes when irradiated by a light. Especially a purple membrane is preferably employed, since it contains bacteriorhodopsins, which is relatively durable. The purple membrane can be separated from halophilic bacteria such as Halobacterium salinarum, as in the step (ii).

The step of forming the light sensitively polarizable layer 13 includes spreading a dispersion containing an light sensitively polarizable molecule over a liquid surface to form a layer of the oriented light sensitively polarizable molecule; adhering the alignment layer of the light sensitively polarizable molecule and the carbon nanotube 7 directly or via the insulating layer 11; and adhering the alignment layer of the light sensitively polarizable molecule to the surface of the transparent substrate 19. Among the above, the step of adhering the alignment layer of the light sensitively polarizable molecule to the surface of the transparent substrate 19 will be subsequently described in the step (v).

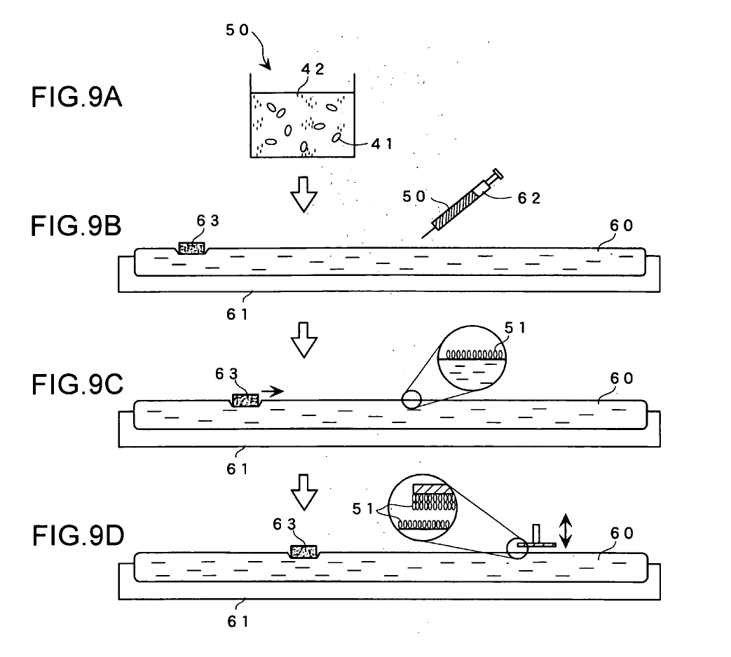

Referring to the progressive cross-sectional drawings of FIGS. 9A to 9D, a case of forming a Langmuir Blodgett (LB) membrane from a purple membrane and forming a light sensitively polarizable layer 13 will be described as an example hereunder.

To start with, a purple membrane including bacteriorhodopsins 41 as a protein component was dispersed in a dispersion medium 42, to prepare a protein spreading liquid 50 (FIG. 9A). The obtained protein spreading liquid 50 is slowly spread over a surface of the filled liquid 60 contained in a tank with a syringe 62 or the like (FIG. 9B). In this embodiment a Langmuir trough 61 is used as the tank. Also, in case of using the bacteriorhodopsin 41, for example 33 v/v % DMF (dimethylformamide) aqueous solution may be used as a dispersion medium 42. In this case, for example an acid solution such as hydrochloric acid aqueous solution prepared at pH 3.5 can be used as the filled liquid 60. Through these steps a protein monolayer film 51 is obtained over the filled liquid 60. At this stage, an orientation of the molecules constituting the protein monolayer film 51 becomes generally uniform because of an amphiphilic feature of the protein on the filled liquid 60. Then static reaction is performed to volatilize the dispersion medium 42. In case of employing a protein or the like as the photosensitive molecule, duration of the keeping static should be set so that surface denaturation does not take place. For example, when using the bacteriorhodopsin 41, the duration is set around 10 minutes.

Then the protein monolayer film 51 formed over the liquid surface of the filled liquid 60 is compressed utilizing a movable barrier 63 of the Langmuir trough 61 as a partition plate, until a predetermined surface pressure is obtained (FIG. 9C). In case of the bacteriorhodopsin 41, the protein monolayer film 51 may be compressed at 20 cm²/min until surface pressure becomes 15 mN/m.

Thereafter, the monolayer film is adhered to the surface of the insulating layer 11 by horizontal transfer method (FIG. 9D). In case of using bacteriorhodopsin for example, a thickness of a layer of the monolayer film 51 becomes approx. 5 nm.

Also, by repeating the horizontal transfer method, the monolayer film 51 can form multi-layer on the surface of the insulating layer 11. When accumulating, rinsing by pure water and drying in an N₂ gas atmosphere is performed each time a new layer is transferred. Since a thickness of the light sensitively polarizable layer 13 can be controlled by adjusting a number of layers, sensitivity of the optical sensor can be controlled.

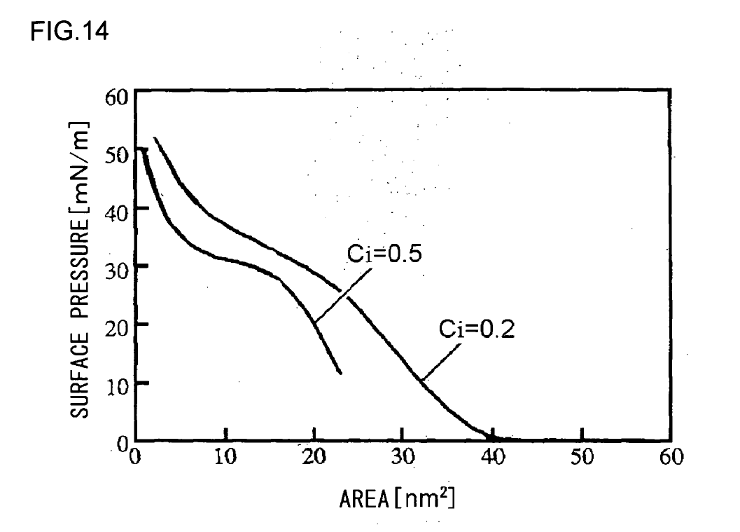

Meanwhile, in case of using hydrochloric acid aqueous solution of pH 3.5 as the filled liquid, Π-A curve of a bacteriorhodopsin molecule becomes as shown in FIG. 14. Referring to FIG. 14, Ci is an index of initial density of bacteriorhodopsin 41 contained in the protein monolayer film 51, which is obtained through the following formula:
Cᵢ=(Number of molecules of bacteriorhodopsin on the filled liquid)×11.5 nm²/area of gas-liquid interface before compression)

In this formula, 11.5 nm² represents an area of a molecule of bacteriorhodopsin 41 obtained through X-ray analysis.

(v) Forming a Multilayered Structure by Bonding the Substrate 3 and the Transparent Substrate 19.

As shown in FIG. 4G, by putting the substrate 3 obtained through the foregoing steps and the transparent substrate 19 in contact with each other with the surfaces of the substrate 3 and the transparent substrate 19 oriented outward, the substrates are bonded and the optical sensor of FIG. 2 is obtained.

Meanwhile, as shown in FIGS. 4E and 4F, the transparent conductive layer 17 and the protective layer 15 are formed in this sequence on either side of the transparent substrate 19. As the transparent substrate 19, a transparent material such as a resin or glass can be employed. Also, as the transparent conductive layer 17, for example a layer of light-transmitting conductive material such as an indium-tin oxide (ITO) can be employed. As the protective layer 15, a transparent insulative material can be utilized, such as glass, a resin, or a denatured protein similar to the insulating layer 11.

In the optical sensor obtained through the foregoing steps, a conductance of the carbon nanotube 7 varies because of a polarization of a protein molecule caused upon receiving a light, which incurs a variation of a value of a current flow between the source electrode 5a and the drain electrode 5b. By detecting such variation, whether a light has been received and the light intensity can be detected. In the optical sensor of this embodiment, the current value between the source electrode 5a and the drain electrode 5b shows a greater variation than a signal generated by the polarization of the protein molecule caused upon receiving a light, therefore connection to a large scale amplifying apparatus, required with a conventional optical sensor, is no longer necessary. Also, the optical sensor of this embodiment is thin and highly sensitive, since the light sensitively polarizable layer 13 is a thin film of a photosensitive molecule. Also, since a pixel 9 is defined by a pair of source electrode 5a and drain electrode 5b connected via the carbon nanotube 7, a number of pixels per unit area is greater (FIG. 5). Further, the optical sensor of this embodiment is a device that converts an optical signal into an electric signal, therefore a current value between the source electrode 5a and the drain electrode 5b can be varied by irradiation of a light.

In addition, in the optical sensor described in this embodiment the source electrode and the drain electrode are two-dimensionally aligned on the substrate surface as shown in FIG. 5, while it is also possible to dispose the electrodes in a single row. Such one-dimensional optical sensor can be applied to, for example, non-contact dimension measurement, position measurement, pattern reading in a facsimile apparatus, and the like.

### Second Embodiment

The step (ii) “Connecting the source electrode 5a and the drain electrode 5b with the carbon nanotube 7” of the first embodiment can be performed in the following method.

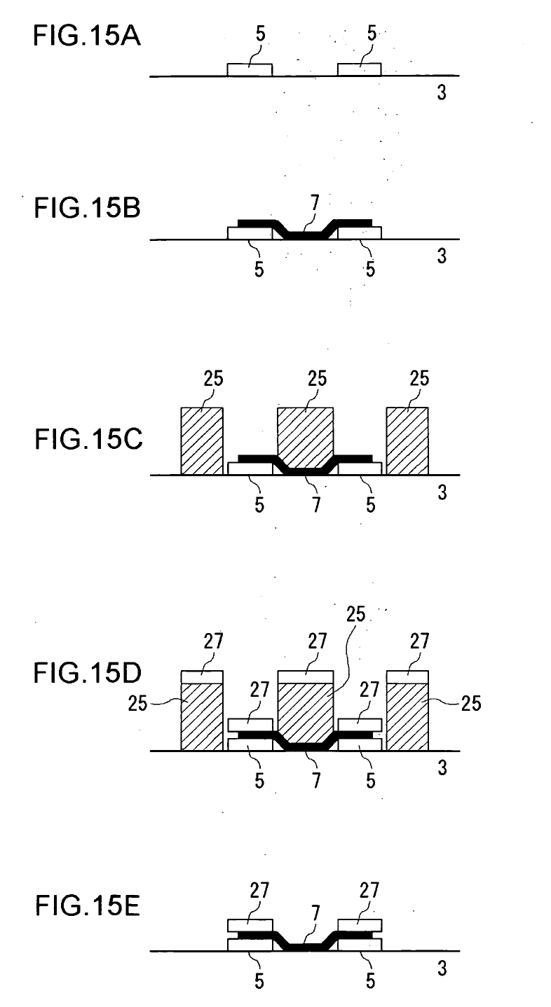

To start with, as shown in FIGS. 15A and 15B, the alignment layer of the carbon nanotube 7 is adsorbed to the substrate 3 where the source electrode 5a and the drain electrode 5b are provided in a similar manner to the first embodiment.

Then as shown in FIG. 15C, a resist layer 25 having an opening at a position corresponding to an upper portion of the source electrode 5a and the drain electrode 5b is formed. Forming the resist layer 25 can be executed by a photo-resist method, for example.

Thereafter as shown in FIG. 15D, a metal layer 27 is formed all over the substrate 3 on which the resist layer 25 is provided. A material of the metal layer 27 can be appropriately selected out of the metals or alloys that can be used for the source electrode 5a and the drain electrode 5b. The source electrode 5a and the drain electrode 5b may be made of the same metal or different metals. Also, forming the metal layer 27 can be executed in a similar manner to the formation of the source electrode 5a and the drain electrode 5b on the substrate 3, for example, by metal vapor deposition or sputtering and the like.

As shown in FIG. 15E, this time the resist layer 25 is removed by a stripper. By such step, the metal layer 27 formed on the resist layer 25 is removed, except on the source electrode 5a and the drain electrode 5b.

Through these steps, the source electrode 5a or the drain electrode 5b and the metal layer 27 are formed on and at the base of the carbon nanotube 7 respectively. With such configuration, contact between the carbon nanotube 7 and a metal constituting the respective electrodes can be improved. Consequently, contact resistance between the carbon nanotube 7 and the source electrode 5a, drain electrode 5b can be reduced, to thereby increase a value of a current flow between the source electrode 5a and the drain electrode 5b.

### Third Embodiment

The step (ii) “Connecting the source electrode 5a and the drain electrode 5b with the carbon nanotube 7” of the first embodiment can be performed in the following method.

Still another method of connecting the source electrode 5a and the drain electrode 5b with the carbon nanotube 7 includes spreading a dispersion of the carbon nanotube 7 over the substrate 3 on which the source electrode 5a and the drain electrode 5b are provided, and moving an appropriate carbon nanotube 7 to a predetermined position with a probe of an AFM or the like.

As a result, the carbon nanotube 7 can be more precisely disposed between the source electrode 5a and the drain electrode 5b.

### Fourth Embodiment

The step (ii) “Connecting the source electrode 5a and the drain electrode 5b with the carbon nanotube 7” of the first embodiment can be performed in the following method.

Still another method of connecting the source electrode 5a and the drain electrode 5b with the carbon nanotube 7 includes adsorbing a catalytic metal to a lateral face of an electrode, and growing the carbon nanotube 7 horizontally along the substrate utilizing the catalytic metal as a growth origin, until the electrodes are connected.

The catalytic metal is not specifically limited as long as the metal can serve as a catalyst for the growth of the carbon nanotube 7, while it is preferable to include at least one of Fe, Co, and Ni. An alloy such as an Fe—Ni alloy or an Ni—Co alloy may also be utilized. For selectively adsorbing the catalytic metal to a portion of the source electrode 5a and the drain electrode 5b, vapor deposition, lithography, sputtering, or patterning with a solution of the catalytic metal can be performed. In such process, it is also effective to appropriately control a vapor deposition temperature, material for the substrate, accumulating method of the catalytic metal, and the like. It is also possible to pattern the catalytic metal by lift-off method.

Also, as a method of growing the carbon nanotube horizontally along the substrate utilizing a catalytic metal as an origin, formation by a chemical vapor deposition (CVD) method is preferably employed. Among the CVD methods, plasma CVD or thermal CVD is available. The plasma CVD is more preferably employed, because this method enables growth of the carbon nanotube under a relatively low temperature.

Examples of a material gas for growing by a CVD method include saturated hydrocarbons such as methane, ethane, propane, butane, pentane, hexane, cyclohexane, and the like; unsaturated hydrocarbons such as ethylene, acetylene, propylene, benzene, toluene, and the like; materials containing oxygen such as acetone, methanol, ethanol, carbon monoxide, carbon dioxide, and the like; and materials containing nitrogen such as benzonitrile and the like, out of which one or a combination of at least two may be employed.

Referring to a carrier gas to be supplied with the material gas to the reaction chamber, for example hydrogen or helium may be employed, however the use of the carrier gas is not imperative.

Further, to achieve a stable structure of the carbon nanotube by growing horizontally along the substrate, it is effective to appropriately control a supply direction of the material gas and growing temperature, or to appropriately adopt a step of growing the carbon nanotube with a magnetic field or an electric field applied thereto.

Through the foregoing steps, the source electrode and the drain electrode can be connected via the carbon nanotube. Thereafter, an electrode can be formed on the carbon nanotube by bonding a metal plate on the electrode surface or vapor-depositing a metal and the like as the case may be. Since such steps enhance the bonding of the carbon nanotube with the source electrode and the drain electrode, contact resistance can be reduced.

### Fifth Embodiment

In the first and the second embodiments, a layer including the aligned carbon nanotubes was formed, so that the source electrode 5a and the drain electrode 5b are connected with the carbon nanotube. Meanwhile, as described referring to the first embodiment, it has been proven that in case a purple membrane is used as a supporting member the supporting component adheres to the surface of the carbon nanotube, in view of FIGS. 17 and 18. As a result of further studies by the present inventors, it has been discovered that the supporting component winds around the surface of the carbon nanotube to thereby form a wrapping of a uniform thickness, during the formation process of the alignment layer, as will be subsequently described in details referring to a working example.

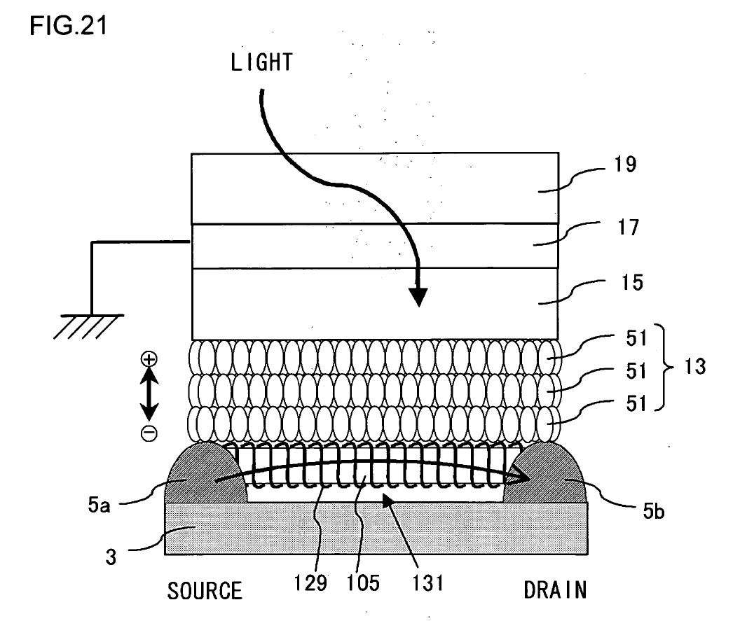

In this embodiment, an optical sensor including such wrapped carbon nanotube will be described. FIG. 21 is a schematic cross-sectional view showing an optical sensor according to this embodiment. A basic structure of the optical sensor of FIG. 21 is the same as that of the first embodiment (FIG. 2). Referring to the optical sensor of FIG. 21, identical numerals are given to the same components as those included in the optical sensor of the first embodiment, and description thereof will not be given as the case may be.

The optical sensor of FIG. 21 is provided with a carbon nanotube-based structure 131 constituted of a carbon nanotube 105 having its surface wrapped with a modified molecule 129, instead of the carbon nanotube 7 of the optical.sensor described in the first embodiment, and is different from the optical sensor of FIG. 2 in that the insulating layer 11 is not provided between the carbon nanotube 7 and the light sensitively polarizable layer 13.

Here, though FIG. 21 schematically shows an optical sensor wherein the modified molecule 129 is wound around the surface of the carbon nanotube 105 so as to form an insulating layer, actually the insulating layer is uniformly wrapping the surface of the carbon nanotube 105. Also, an aspect of the insulating layer is not limited to being wound around the carbon nanotube 105, as long as the insulating layer uniformly wraps the surface of the carbon nanotube 105.

By winding the modified molecule 129 around the surface of the carbon nanotube 105, a thin wrapping layer of a uniform thickness constituted of the wound layer can be formed over the surface of the carbon nanotube 105. Since a wrapping layer of a uniform thickness is formed, operational stability of the optical sensor can be improved. Consequently, reliability of the optical sensor can be upgraded. Also, since a thin wrapping layer is formed, a polarization that takes place in the light sensitively polarizable layer 13 can be precisely converted to a conductance variation of the carbon nanotube.

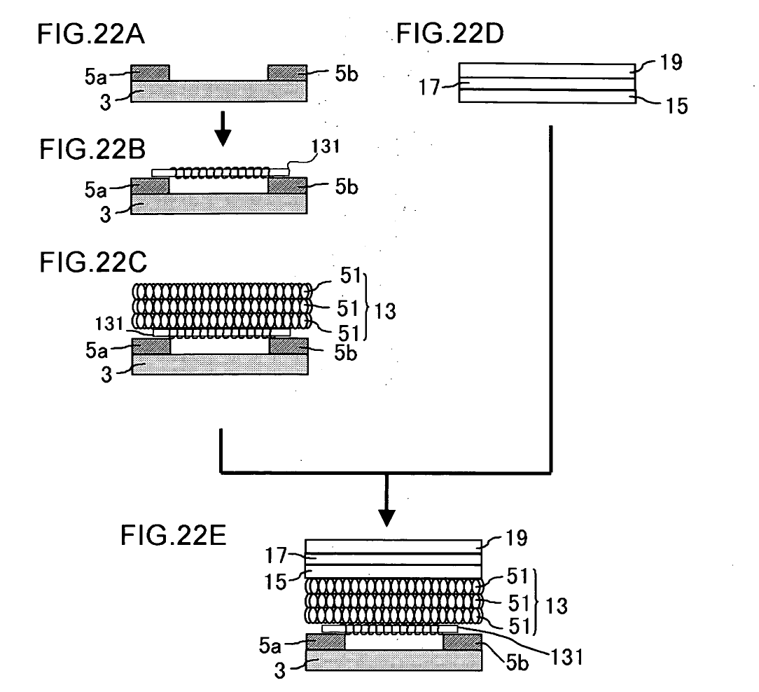

Hereunder, a method of manufacturing the optical sensor of FIG. 21 will be described. FIGS. 22A to 22E are schematic cross-sectional views showing manufacturing steps of the optical sensor of FIG. 21.

Referring to FIGS. 22A to 22E, firstly the source electrode 5a and the drain electrode 5b are formed on the substrate 3 (FIG. 22A). Then the source electrode 5a and the drain electrode 5b are connected with the carbon nanotube-based structure 131 (FIG. 22B), on which the light sensitively polarizable layer 13 is formed (FIG. 22C). Thereafter the substrate 3 and the transparent substrate 19 are joined, so as to form a multilayered structure (FIG. 22E). By the way, the transparent conductive layer 17 and the protective layer 15 are formed in this sequence on either side of the transparent substrate 19 (FIG. 22D). As shown in FIG. 22E, the protective layer 15 is attached to the light sensitively polarizable layer 13. In this way the optical sensor of FIG. 21 is obtained.

Among the foregoing steps, for forming the source electrode 5a and the drain electrode 5b on the substrate 3 (FIG. 22A), the method described in the first embodiment can be employed.

Also, connection of the source electrode 5a and the drain electrode 5b with the carbon nanotube-based structure 131 (FIG. 22B) can be performed through forming a layer of the aligned carbon nanotube-based structure 131, adhering the obtained alignment layer to the surface of the substrate 3, removing an unnecessary portion of the carbon nanotube-based structure 131, and removing the modified molecule 129 on the source electrode 5a and the drain electrode 5b. These steps will be described later.

Also, for forming the light sensitively polarizable layer 13 on the carbon nanotube-based structure (FIG. 22C) and bonding the substrate 3 and the transparent substrate 19 to form a layered structure (FIG. 22E), the method described in the first embodiment can be employed.

Hereunder, the respective steps of connecting the source electrode 5a and the drain electrode 5b with the carbon nanotube-based structure 131 (FIG. 22B) will be described in details.

To start with, formation of a layer including the aligned carbon nanotube-based structure 131 is performed by the method described in the first embodiment (FIG. 6). In the carbon nanotube-based structure 131, an insulating layer wrapping the carbon nanotube 105 may be formed in a film thickness of for example 0.1 nm to 100 nm both inclusive, and it is preferable to adopt a thickness of 10 nm or less. In this way the insulating layer can be made sufficiently thin. Consequently, it becomes possible to incur a greater variation of conductance of the carbon nanotube 105 to be caused by an induced charge generated by a polarization of the light sensitively polarizable layer 13. As a result, a still higher sensitivity can be granted to the optical sensor.

Adsorption of the alignment layer to the surface of the substrate 3 can be performed by horizontal transfer method, and the like.

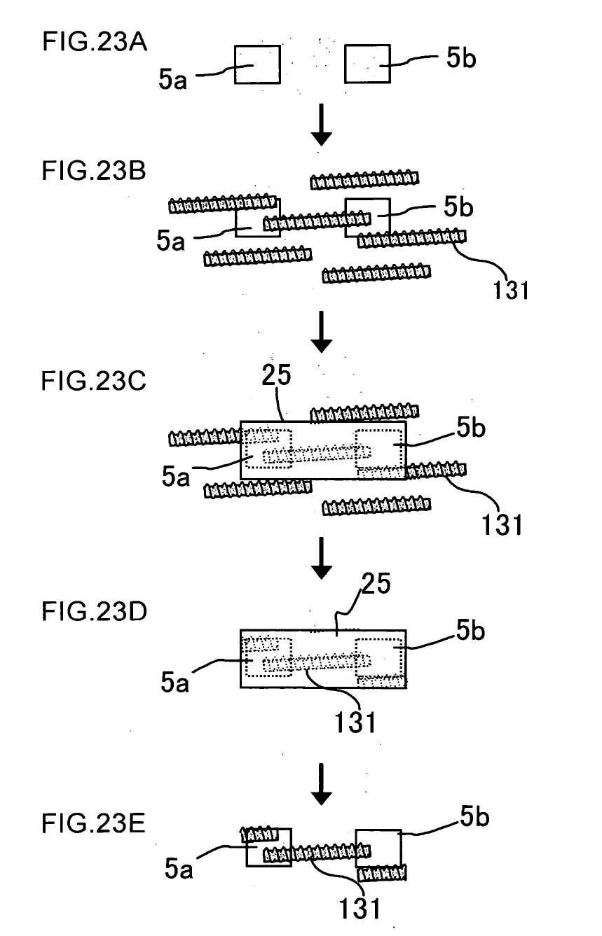

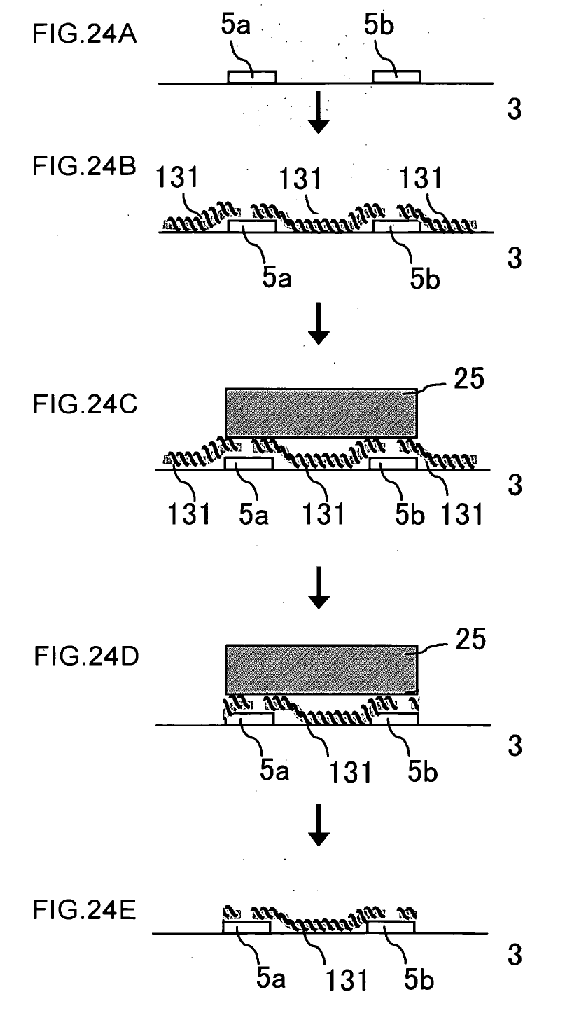

Removal of a surplus of the carbon nanotube-based structure 131 is performed through the steps shown in FIGS. 23A to 23E and 24A to 24E. Here, FIGS. 23A to 23E are schematic top views of the steps, and FIGS. 24A to 24E are the cross-sectional views respectively corresponding thereto.

FIGS. 23B and 24B show a state where the alignment layer of the carbon nanotube-based structures 131 are adsorbed to the substrate 3 (FIGS. 23A and 24A) on which the source electrode 5a and the drain electrode 5b are provided.

The patterned resist layer 25 is formed in order to remove the carbon nanotube-based structures 131 adsorbed to an unnecessary region leaving only the carbon nanotube-based structures 131 adsorbed to an upper portion of the source electrode 5a and the drain electrode 5b and between the electrodes (FIGS. 23C and 24C).

Then the carbon nanotube-based structures 131 in a region not covered with the resist layer 25 are removed by dry etching, wet etching, or the like (FIGS. 23D and 24D). After this the resist layer 25 is removed by a solution that dissolves the resist layer 25 without dissolving the modified molecule 129 or the carbon nanotube 105 (FIGS. 23E and 24E).

In this way the carbon nanotube-based structures 131 in an unnecessary region are removed.

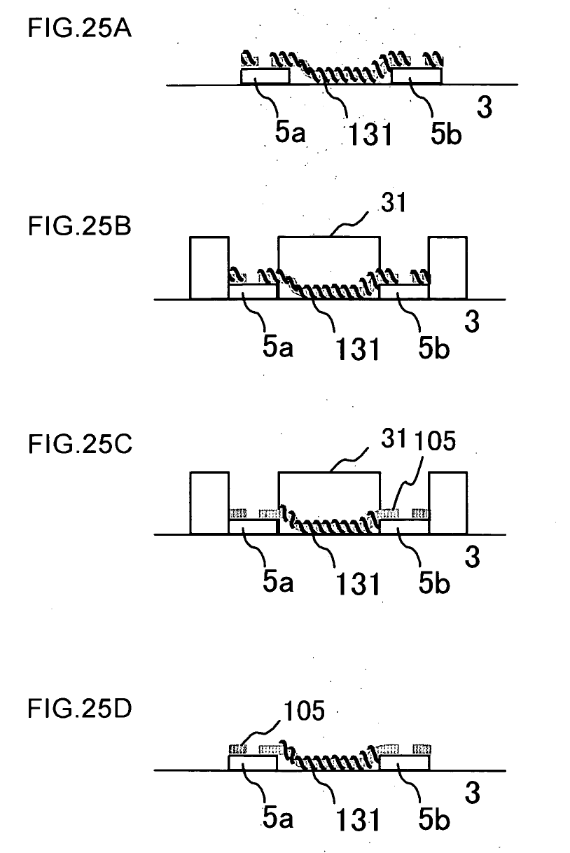

Thereafter, removal of the modified molecule 129 on the source electrode 5a and the drain electrode 5b is performed as follows. FIGS. 25A to 25D are schematic cross-sectional views showing the steps of removing the modified molecule 129 on the source electrode 5a and the drain electrode 5b.

A resist layer 31 having an aperture at a position corresponding to an upper portion of the source electrode 5a and the drain electrode 5b is formed all over the substrate 3 from which the surplus carbon nanotube-based structures have been removed (FIG. 25A), by plasma CVD method or the like (FIG. 25B). As a result, the end portions of the carbon nanotube-based structure 131 are exposed.

Then at least a part of the modified molecule 129 on a rounded face of the exposed carbon nanotube-based structure 131 is removed by such a method as ashing (FIG. 25C). At this stage, the carbon nanotube 105 becomes uncovered only on the electrodes. For the ashing process, oxygen plasma may be employed. Also, plasma of nitrogen or nitrogen-containing gas may be used.

Then the resist layer 31 is removed by a solution that dissolves the resist layer 31 without dissolving the carbon nanotube 105 (FIG. 25D).

In this way the modified molecule 129 on the electrodes is removed. By removing the modified molecule 129 on the electrodes, electric connection between the carbon nanotube 105 and the electrodes can be improved.

Also, in case where a metal capable of forming a carbide is included in the surface of the source electrode 5a or the drain electrode 5b, a carbide is formed at an interface between the carbon nanotube 105 and the source electrode 5a or the drain electrode 5b by appropriately performing an annealing process, for example heating up to higher than 1000 degree centigrade in vacuum, after the step of FIGS. 23B and 24B, and resultantly electric contact can be improved.

Further, it is also possible to provide on the surface of the substrate 3 a mask having an aperture only at a position corresponding to an upper portion of the electrodes, to thereby form a metal layer that further constitutes an electrode on the source electrode 5a and the drain electrode 5b respectively, as in the first embodiment. As a result of such constitution, the carbon nanotube 105 connecting the source electrode 5a and the drain electrode 5b is disposed between the upper and lower metal layers, thereby achieving better electric contact.

Furthermore it is also possible to provide on the substrate 3 a mask having an aperture only at a position corresponding to an upper portion of the electrodes, so as to form a thin insulating layer on top of the source electrode 5a and the drain electrode 5b respectively. In this way, the source electrode 5a, the drain electrode 5b and the carbon nanotube 105 exposed on these electrodes can be prevented from directly contacting with the light sensitively polarizable layer 13. Also, in case where a metal layer that further constitutes an electrode is formed on the source electrode 5a and the drain electrode 5b respectively as already described, the metal layer can be prevented from directly contacting with the light sensitively polarizable layer 13. Therefore, precision of the optical sensor can be further improved.

As described above, according to this embodiment, since the modified molecule 129 is wound around an outer circumference of the rounded surface of the carbon nanotube 105, the modified molecule 129 forms a uniform insulating layer on the surface of the carbon nanotube-based structure 131. Therefore, the light sensitively polarizable layer 13 can be directly adhered to the carbon nanotube-based structure 131 without need to form an insulating layer on the carbon nanotube 105. Consequently, an optical sensor of a simplified constitution can be stably manufactured.

Also, a layer of the modified molecule 129 which is an insulating layer on the surface of the carbon nanotube 105 uniformly constitutes a thin film of a thickness range of, for example, 0.1 nm to 100 nm both inclusive on the surface of the carbon nanotube 105. Accordingly, a polarization that takes place in the light sensitively polarizable layer 13 can be precisely converted into a variation of conductance of the carbon nanotube 105 while securely insulating the light sensitively polarizable layer 13 from the carbon nanotube 105. Further, since a wrapping of a uniform thickness constituted of the modified molecule 129 is provided around the carbon nanotube 105, operational stability of the optical sensor is improved. In addition, such wrapping of the modified molecule 129 restrains surrounding moisture fromaffecting conductivity of the carbon nanotube 105. Consequently, precision and sensitivity of the optical sensor can be further upgraded.

### Sixth Embodiment

The optical sensor according to this embodiment is provided with a plurality of electrode pairs consisting of a source electrode and a drain electrode two-dimensionally aligned on a surface of a substrate. Structure of each sensor unit is similar to the sensor of the first embodiment. The optical sensor of this embodiment can be suitably applied for an image recognition device or an image sensor of a TV camera, and the like. Hereunder, an example where the optical sensor of this embodiment is employed as an image recognition device will be described.

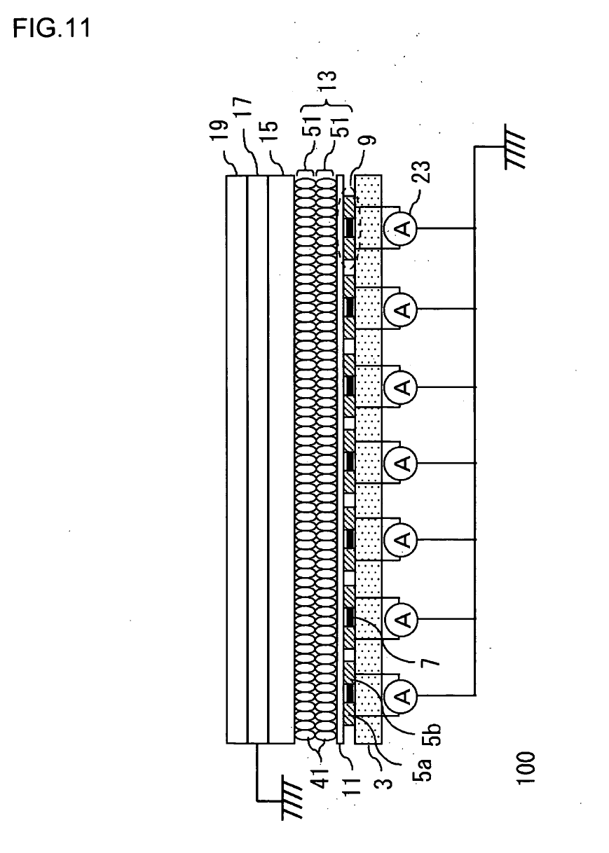

An image recognition device 100 according to this embodiment is shown in FIG. 11. The image recognition device 100 can be manufactured in a similar manner to the first embodiment. Referring to FIG. 11, for example monocrystalline silicon is used as the substrate 3. A purple membrane is used in the light sensitively polarizable layer 13. Since a protein monolayer film 51 including bacteriorhodopsin 41 and lipid can be obtained from such material, this is layered so as to constitute the light sensitively polarizable layer 13. Also, the insulating layer 11 is constituted of the purple membrane.

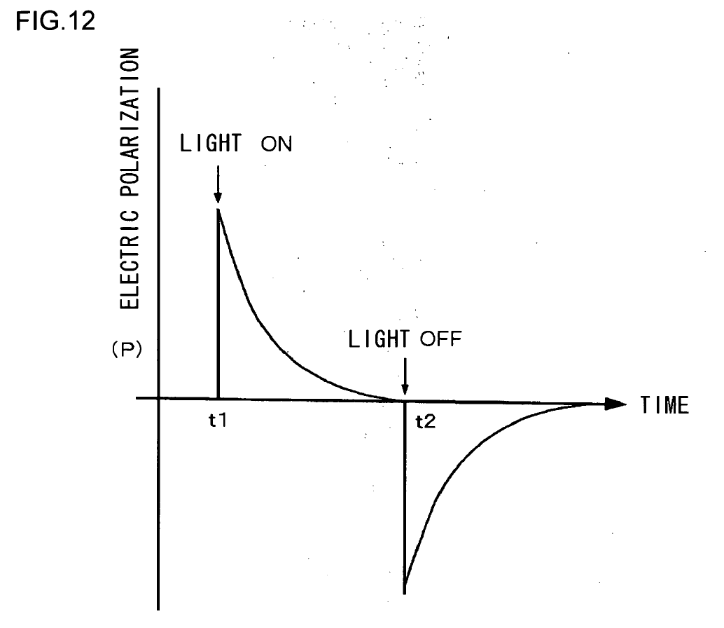

Upon irradiating a light on the bacteriorhodopsin 41, an electric polarization takes place, and the electric polarization characteristics are as shown in FIG. 12. Specifically, a light irradiation at the time t₁ causes an electric polarization, which gradually attenuates with the lapse of time. And upon suspending the light irradiation at the time t₂, an electric polarization of a reverse polarity to that caused by light irradiation takes place, which gradually attenuates with the lapse of time.

In the image recognition device 100 of this embodiment, a current value between the source electrode 5a and the drain electrode 5b of each pixel 9 is detected by a detector 23. Therefore both resolution and sensitivity are high.

Also, when detecting a contour of a moving object with the image recognition device 100 of this embodiment, the contour can be more precisely captured than a conventional image recognition device.

A conventional contour extraction of a moving object in an image utilizes a differential image obtained by picking up a data differential between continuous frame images acquired by an input device such as CCD. Such method is hereinafter referred to as “data differential method”. The data differential method utilizes the fact that difference between two continuous frame images generally corresponds to a contour of a moving object in the images.

Accordingly, contour data of a moving object extracted by the data differential method depends on a background image data of the moving object. In other words, even though light intensity of the moving object is constant, in the event that light intensity around the moving object varies, the contour data that is a differential value cannot remain constant. Therefore, under a condition that light intensity of background is variable, it is difficult to precisely detect a contour.

By contrast, the image recognition device 100 of this embodiment is capable of extracting a contour of a moving object without depending on the data differential, as described below.

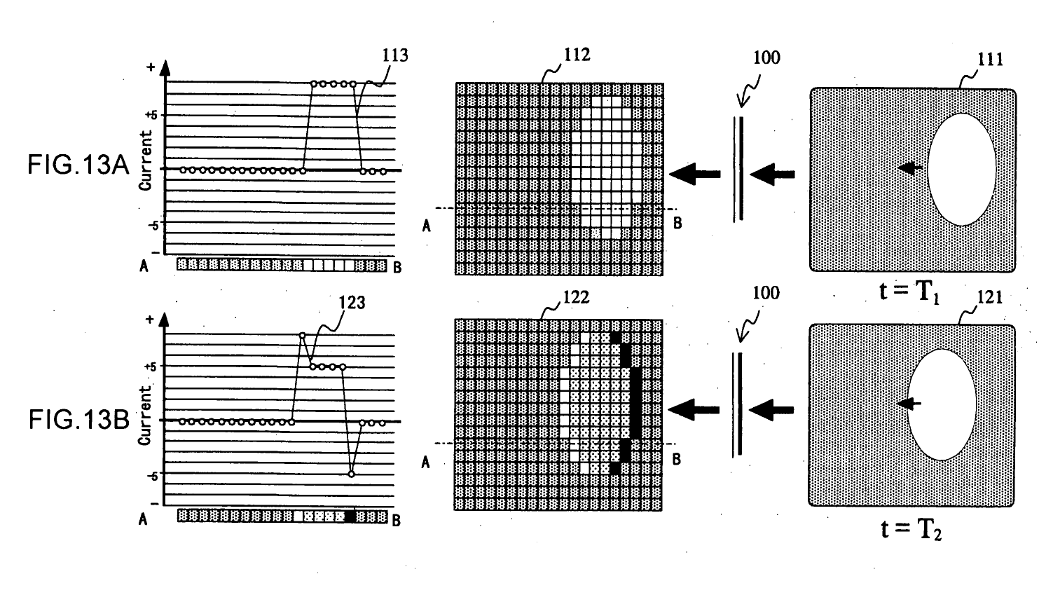

FIGS. 13A and 13B show an output image obtainable by the image recognition device 100 when a moving image including a moving object is irradiated to the image recognition device 100 of FIG. 11.

Referring to FIG. 13A, 111 shows an input image at the time t=T₁, 112 an output image with respect to the input image at t=T₁, and 113 an output current value of the output image with respect to the input image at t=T₁ on the line A-B, respectively. Here, the input image means optical information, therefore actually a light of the moving object has been first irradiated at t=T₁ to the image recognition device 100.

Also in FIG. 13B, 121 shows an input image at the time t=T₂, 122 an output image with respect to the input image at t=T₂, and 123 an output current value of the output image with respect to the input image at t=T₂ on the line A-B, respectively.

At t=T₁, an induced current of a predetermined value according to a light intensity of the moving object (+8 according to FIG. 13A) is generated in a pixel 9 corresponding to a position where the light of the moving object has been irradiated, based on the electric polarization characteristics of the light sensitively polarizable layer 13 (FIG. 12) of the image recognition device 100.

Then at t=T₂, an induced current of a predetermined value (+8 according to FIG. 13B) is generated in a pixel 9 corresponding to a position where the light of the moving object has been newly irradiated. On the other hand, the induced current to the pixel 9 corresponding to a position where the light of the moving object has continuously been irradiated since t=T₁ drops to a predetermined value (+8 to +5 according to FIG. 13B) based on the electric polarization characteristics of the light sensitively polarizable layer 13 of the image recognition device 100. Meanwhile, an induced current to a pixel 9 corresponding to a position where the light of the moving object was irradiated at t=T₁ but no longer irradiated at t=T₂, varies to a predetermined value of the reverse polarity according to the light intensity of the moving object (−5 according to FIG. 13B), based on the electric polarization characteristics of the light sensitively polarizable layer 13.

Accordingly, the induced current value corresponding to a position where the light of the moving object has been newly irradiated, i.e. corresponding to a contour on the forward side of the moving object in its moving direction becomes a predetermined constant value according to the light intensity of the moving object (+8 according to FIGS. 13A and 13B). Also, the induced current value corresponding to a position where the light of the moving object is no longer irradiated, i.e. corresponding to a contour on the rear side of the moving object in its moving direction becomes a predetermined constant value according to the light intensity of the moving object (−5 according to FIG. 13B). Therefore, when detecting a moving object with the image recognition device 100, the induced current value becomes constant as long as luminosity of background is constant. Also, an induced current value corresponding to a position where the light of the moving object has continuously been irradiated, and to a position where the light has stopped being irradiated becomes 0 (zero) with the lapse of time.

According to the foregoing explanation, an image within a contour of a moving object extracted by the image recognition device 100 of this embodiment is a real image. Therefore, even though a background of moving images being input is a complicated image including patterns, a contour of a moving object can be independently extracted, without depending on the background. Also, by chasing a contour of a moving object, a moving direction of the object can be extracted.

Further, in case of the image recognition device 100 of this embodiment, since the pixel 9 is of minute dimensions, a number of pixels per unit area can be increased up to around 100 million pieces. Accordingly, a contour of a moving object can be more precisely extracted.

Furthermore, in the pixel 9 constituting the image recognition device 100 of this embodiment, conductance of the carbon nanotube 7 varies because of a polarization of the bacteriorhodopsin 41, which leads to a variation of a current value between the source electrode 5a and the drain electrode 5b, therefore the variation of the current value is relatively large, and resultantly a contour of a moving object can be sensitively extracted.

### Seventh Embodiment

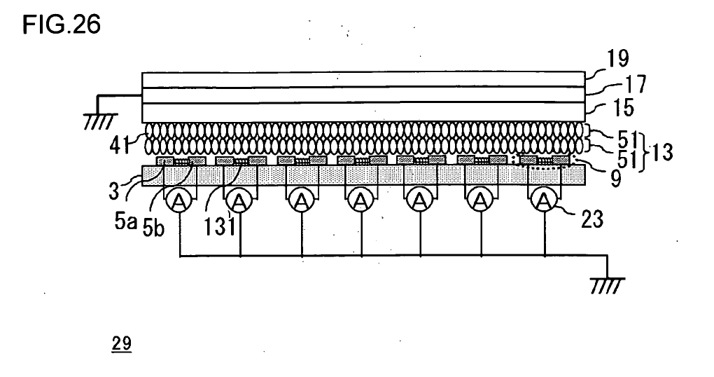

This embodiment relates to an image recognition device provided with an optical sensor described in the fifth embodiment. FIG. 26 shows a constitution of an image recognition device 29. Referring to the image recognition device 29, identical numerals are given to the same components as those included in the image recognition device of the sixth embodiment, and description thereof will not be given as the case may be.

In the image recognition device 29, the source electrode 5a and the drain electrode 5b are connected via the carbon nanotube-based structure 131. In the carbon nanotube-based structure 131, the modified molecule 129 is uniformly wrapping around the carbon nanotube 105. A thin insulating layer constituted of the modified molecule 129 is formed around the carbon nanotube-based structure 131. Therefore, a polarization can be precisely and stably caused in the protein monolayer film 51 without need to provide an insulating layer 11 between the light sensitively polarizable layer 13 and the carbon nanotube 105. For the light sensitively polarizable layer 13, for example a purple membrane can be employed.

For manufacturing the image recognition device 29, the method described in the fifth and the sixth embodiments can be employed.

The present invention has been described as above based on various embodiments. It is to be understood that these embodiments are only exemplary, and that it is apparent to those skilled in the art that various modifications can be made to constituents or process or a combination thereof, without departing from the scope and spirit of the present invention.

### WORKING EXAMPLE

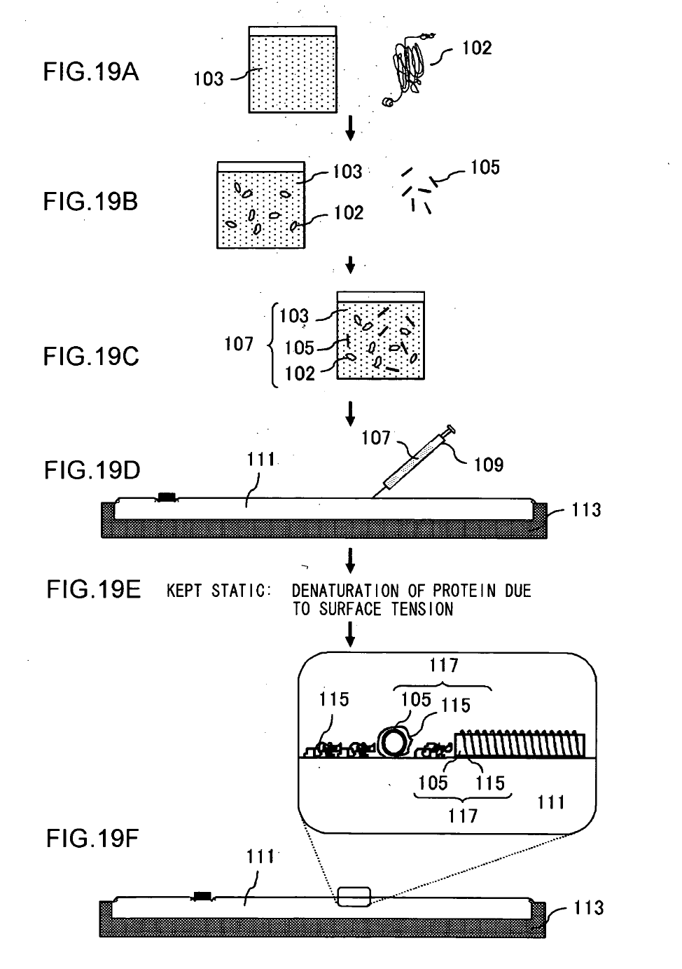

The working example represents manufacturing of a carbon nanotube-based structure constituted of a carbon nanotube with its surface wrapped with an insulating layer of denatured bacteriorhodopsin. FIGS. 19A to 19F show a method of manufacturing such carbon nanotube-based structure 117.

Firstly, a purple membrane including bacteriorhodopsins 102 was dispersed in a dispersion medium (FIG. 19A). As the bacteriorhodopsin 102, for example either a purple membrane or bacteriorhodopsins 102 contained in the purple membrane may be employed, out of which the purple membrane was used in this working example. The purple membrane can be extracted from halophilic bacteria such as Halobacterium salinarum. For extraction of the purple membrane, the method described in “Methods in Enzymology” 31, A, pp. 667-678 (1974) was adopted. Also, 33 v/v % DMF (dimethylformamide) aqueous solution was used as the dispersion medium 103. By the way, as the dispersion medium 103 an organic aqueous solution or the like may be used, without limitation to the 33 v/v % DMF aqueous solution.

An excessive amount of carbon nanotube 105 was added to the dispersion of the bacteriorhodopsin 102, and dispersion treatment was performed for more than an hour utilizing an ultrasonic disperser (FIG. 19B). After the dispersion process, aggregation of residual carbon nanotube 105 was removed. As the carbon nanotube 105, a multi-wall carbon nanotube manufactured by MTR Ltd. (closed end type, several dozen to approx. 200 nm in diameter and approx. 95% in purity) was employed.

The dispersion 107 thus obtained (FIG. 19C) was slowly spread over a surface of the filled liquid 111 contained in a water tank with the syringe 109 (FIG. 19D). At this stage, an interface film including the carbon nanotube 105 was obtained. Meanwhile, in this working example a Langmuir trough 113 was used as the water tank, and pure water adjusted at pH 3.5 with HCl was used as the filled liquid 111.

Then the interface film including the carbon nanotube 105 was kept static so that surface denaturation of the bacteriorhodopsin 102 was incurred because of a surface tension of the filled liquid 111. In case of using the purple membrane, it is preferable to keep static for at least five hours at a room temperature in order to entirely denature the bacteriorhodopsins in the purple membrane, therefore this step was continued five hours in this working example (FIG. 19E). Through such process, the denatured bacteriorhodopsin 115 winds around a rounded surface of the carbon nanotube 105 (FIG. 19F).

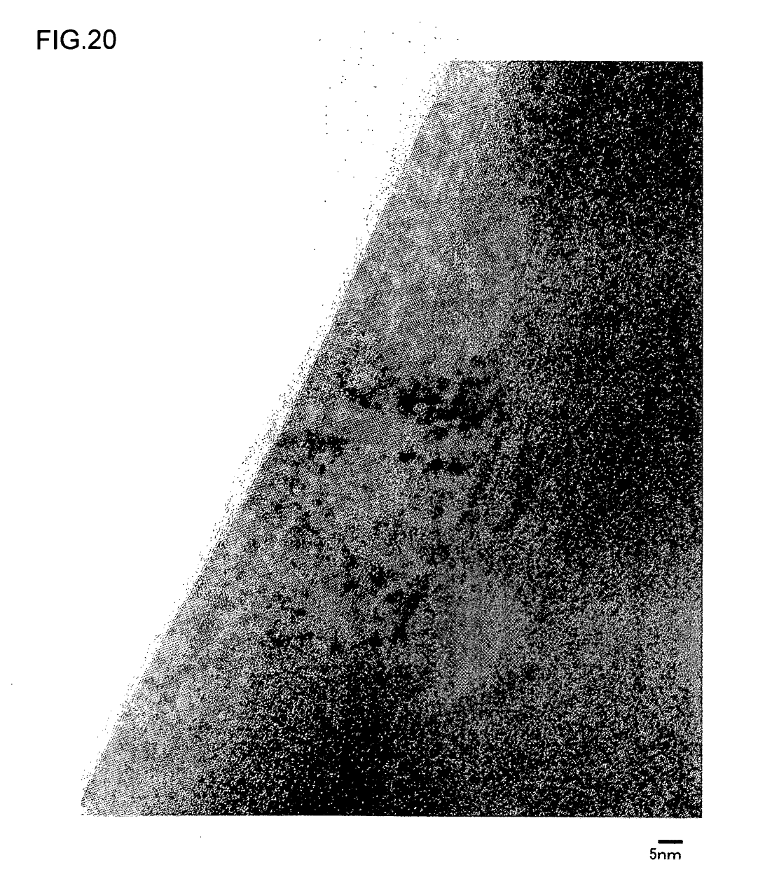

The carbon nanotube-based structure 117 formed on the water surface was transferred onto a TEM observation grid together with the interface film, and was observed as it was through the TEM (transmission electron microscope) after drying. FIG. 20 shows a TEM image of the carbon nanotube-based structure 117. As shown in FIG. 20, a uniform layer of the denatured bacteriorhodopsin 115 was formed on the surface of the carbon nanotube 105. In addition, thickness of this layer was approx. 3 nm.

As described above, in this working example the carbon nanotube-based structure 117 was obtained through a simple process of dispersing the bacteriorhodopsins 102 and the carbon nanotubes 105 and spreading over a liquid surface.

By adhering the carbon nanotube-based structure 117 thus obtained on a substrate, an optical sensor can be stably manufactured.

1. An optical sensor comprising:
a substrate;
a source electrode and a drain electrode formed on said substrate;
a carbon nanotube for electrically connecting said source electrode and said drain electrode; and
a light sensitively polarizable layer disposed on said carbon nanotube.

2. The optical sensor as set forth in claim 1, wherein said light sensitively polarizable layer mainly contains a molecule that polarize on being subjected to a light.

3. The optical sensor as set forth in claim 1, wherein said light sensitively polarizable layer contains bacteriorhodopsin.

4. The optical sensor as set forth in claim 1, wherein said carbon nanotube is provided with an insulating layer on a surface thereof.

5. The optical sensor as set forth in claim 4, wherein said insulating layer is a polymer layer.

6. The optical sensor as set forth in claim 4, wherein said insulating layer is constituted of a polymer layer wrapped a rounded surface of said carbon nanotube.

7. The optical sensor as set forth in claim 4, wherein said insulating layer is constituted of a polymer wound around a rounded surface of said carbon nanotube.

8. A method of manufacturing an optical sensor comprising:
forming a source electrode and a drain electrode on a substrate;
connecting said source electrode and said drain electrode with a carbon nanotube; and
forming a light sensitively polarizable layer on said carbon nanotube.

9. The method as set forth in claim 8, wherein said connecting said source electrode and said drain electrode with said carbon nanotube comprising:
forming a layer including aligned carbon nanotubes;
adhering said alignment layer of said carbon nanotube to a surface of said source electrode and said drain electrode; and
selectively removing said carbon nanotube adhered to a region other than on said source electrode, said drain electrode and between said source electrode and said drain electrode.

10. The method as set forth in claim 9, wherein said a layer including aligned carbon nanotubes includes spreading a dispersion in which said carbon nanotube and a wrapping molecule are dispersed over a liquid surface, for forming an insulating layer including said wrapping molecule on said carbon nanotube surface.

11. The method as set forth in claim 10, wherein a polymer is utilized as said wrapping molecule for forming a layer of said polymer on said carbon nanotube surface.

12. The method as set forth in claim 10, wherein a protein is dispersed as said wrapping molecule in said spreading said dispersion such that said protein is denatured, and said denatured protein is wrapped a rounded surface of said carbon nanotube.

13. The method as set forth in claim 10, wherein a protein is dispersed as said wrapping molecule in said spreading said dispersion such that said protein is denatured, and said denatured protein is wound around a rounded surface of said carbon nanotube.

14. The method as set forth in claim 12, wherein said protein is a membrane protein.

15. The method as set forth in claim 13, wherein said protein is a membrane protein.

16. The method as set forth in claim 9, wherein said forming a layer including aligned carbon nanotubes includes spreading a dispersion containing said carbon nanotube and a bacteriorhodopsin over a liquid surface so as to form an alignment of said carbon nanotube.

17. The method as set forth in claim 8, wherein the step of forming said light sensitively polarizable layer includes forming a monolayer film of a molecule that polarizes on being subjected to a light or a multilayered film thereof.

18. The method as set forth in claim 8, wherein the step of forming said light sensitively polarizable layer includes forming a layer of oriented bacteriorhodopsins.

19. The method as set forth in claim 17, wherein the step of forming said light sensitively polarizable layer includes:
spreading a dispersion containing a molecule which polarize on being subjected to a light to form a layer of oriented molecules which polarize on being subjected to a light; and
adhering said layer of said molecule that polarizes on being subjected to a light and said carbon nanotube either directly or via an insulating layer.

20. A method of driving said optical sensor defined in claim 1 comprising:
supplying a predetermined current between said source electrode and said drain electrode and detecting a variation of a value of said current to thereby detect intensity of a received light.

21. A method of detecting light intensity utilizing a sensor including a light sensitively polarizable layer and a carbon nanotube provided in the proximity thereof comprising:
applying a voltage to said carbon nanotube;
detecting variation of a current value in said carbon nanotube caused by irradiation of a light to said layer; and
detecting light intensity based on the variation of said current value.

22. The method as set forth in claim 21, wherein said light sensitively polarizable layer contains bacteriorhodopsin.
